(19) United States
(12) Patent Application Publication
(10) Pub. No.: US 2022/0074195 A1
(43) Pub. Date: Mar. 10, 2022

(54) BASE FOR USE WITH A TEMPORARY HABITABLE ENCLOSURE OR NON-ENCLOSED AREA

(71) Applicant: META - BASE HOLDINGS LLC, Boston, MA (US)

(72) Inventors: William Pitt, Boston, MA (US); Z. A. Rahman, Boston, MA (US)

(21) Appl. No.: 17/294,992

(22) PCT Filed: Nov. 19, 2019
(86) PCT No.: PCT/US2019/062227

§ 371 Date: May 18, 2021

Related U.S. Application Data
(60) Provisional application No. 62/769,138, filed on Nov. 19, 2018.

(51) Int. Cl. E04B 1/348

(52) U.S. Cl. CPC E04B 1/34869

(57) ABSTRACT

A base (100) for use with a temporary habitable enclosure or non-enclosed area houses a centralized, modular MEP system affording highly efficient use of floorplan to provide a variety of utilities and associated functionality to the occupants. The base includes a housing (20) forming several compartments containing MEP system components, appliances, and fixtures (30,40,50,60). The housing may include a structural frame and external cladding providing options for interior and exterior aesthetic and environmental protection, while providing access to the compartments. An integrated network interconnects the MEP system with the fixtures and appliances, such as ambient environment regulating devices, plumbing and lighting devices, and cooking devices. Different configuration bases can be used in different applications, including those that are stand-alone off-grid, those that are connected to temporary or local grid service(s), or those that are connected to existing permanent grid service(s).

### CROSS-REFERENCE TO RELATED APPLICATION

This application claims priority to and the benefit of U.S. Provisional Patent Application No. 62/769,138 filed on Nov. 19, 2018, the entire disclosure of which is incorporated in its entirety by reference herein.

### TECHNICAL FIELD

In various embodiments, the present invention relates generally to utility systems for temporary habitable enclosures as well as outdoor areas that are not necessarily enclosed by a temporary or other structure and, more specifically, to a base for centralizing and providing mechanical, electrical, and plumbing (MEP) systems in a portable modular accessible structure with point of use appliances and fixtures for use by occupants of a temporary habitable enclosure or non-enclosed outdoor area. Alternatively, built-in, original MEP appliances and fixtures may be used in lieu of point-of-use appliance and fixtures.

### BACKGROUND

Temporary housing is provided and basic living needs are met by governmental organizations, non-governmental organizations (NGOs), and other charitable relief agencies for those temporarily displaced from permanent habitable dwellings due to weather-related incidents (e.g., flooding, tornadoes, hurricanes, etc.), natural disasters (e.g., wildfires, earthquakes, tsunamis, and volcanic activity), and man-made tragedies (e.g., wars, insurrections, civil unrest, etc.). Displaced persons and families, refugees, and others fleeing such situations require temporary housing or shelter out of harm's way, as well as food, sanitary services, healthcare services, security and safety services, and the like. Enclosures such as tents or shelters and other modular enclosures can be rapidly deployed to provide shelter from the elements and a place to sleep, but many essentials can only be provided by centralized kitchen, bathing, and sanitary facilities. When stays at these temporary encampments extend for months or longer, living conditions deteriorate. The resultant toll on the health, strength, well-being, and dignity of the inhabitants can significantly affect physical and mental health.

Accordingly, a need exists for an improved approach to supporting the basic needs and dignity of individuals living in temporary habitable enclosures or non-enclosed areas.

### SUMMARY OF THE INVENTION

Although embodiments of this invention will be described in terms of use of the base in conjunction with a temporary habitable enclosure, those of ordinary skill can appreciate that the described base may also be used with or in a non-enclosed area, i.e., in some instances, non-enclosed areas may be used instead of enclosed tents, shelters, and the like.

In various embodiments, the base provides a portable personal MEP utility system housed in a centralized, space-efficient manner that can be deployed rapidly to accommodate the various and necessary needs of a family or other small group of individuals temporarily housed together in a tent, shelter, or other enclosure. In some embodiments, the base can be a stand-alone structure, unconnected to any services. Optionally, certain embodiments of the base can include a common, yet flexible, interface system for mating with supply systems (e.g., water, sewer, and the like), as well as centralized collection and distribution systems servicing more than one temporary habitable enclosure, such as a fixed grid or a localized or temporary grid. In still other embodiments, the base can be connected to one or more services of an existing (e.g., fixed, temporary, micro-, and the like) grid. The base may be rapidly deployed by a myriad of organizations or business elements, including, for the purpose of illustration, rather than limitation: a relief agency, a humanitarian aid entity, a for-profit commercial entity, and so forth to supplement and, to a large extent, decrease the reliance of the individuals on centralized kitchen, bathing, and sanitary facilities, as well as to decrease reliance on centralized MEP systems, facilities, or infrastructure. This can be especially important for assisting infants, the elderly, and/or individuals with mobility issues. The base also is available for use by the inhabitants of the tent, shelter, or enclosure around the clock, regardless of ambient weather conditions, and when leaving the enclosure may present a safety issue, such as at night. Embodiments of the base described herein address many of the above-mentioned issues that are present in existing temporary encampments and approaches to servicing the needs of displaced individuals, as well as off-the-grid living, and are a substantial and material improvement over those existing approaches.

In general, in one aspect, embodiments of the invention feature a base adapted for use in a temporary habitable enclosure to provide utilities to occupants thereof. The base can include a housing or structural frame forming a plurality of compartments, each compartment adapted to contain at least a portion of an MEP system, an appliance, or a fixture. The housing may have access panels, doors, drawers, ventilation systems, internal heat recovery systems, etc. In embodiments employing a structural frame, external cladding may be coupled to the structural frame, to enclose and provide access to the various compartments. Alternatively, for mass production applications, a mold made of a new material that combines structural elements plus building/finishing elements and that is made of recycled elements that can be heavy duty environment/waterproof may be produced. The mold can have compartments that fit in with specific mechanisms.

The base also includes an integrated network interconnecting the MEP system with the fixtures and the appliances. In some embodiments, the MEP system may include at least one ambient environment regulating device, the fixtures include at least one plumbing device and one lighting device, and the appliances include at least one cooking device.

The base housing or structural frame may have a substantially rectilinear external shape and, when clad externally, the external cladding may include at least one removable panel and/or at least one openable panel, such as a hinged door or a drawer or, alternatively, a plug-in compartment that contains original, built-in fixtures or appliances. Suitable mechanisms can be provided for MEP connections to appliances and devices, as well as for accessibility during usage and maintenance activities. The housing or external cladding may have a finished surface suitable for exposure to an interior living space of the temporary habitable enclosure, a weather resistant surface suitable for exposure to ambient environment external to the habitable enclosure, and combinations thereof.

The various components of the integrated network and system of the base can include electrical power cabling, data/communications cabling, environment regulating ducting, fluid supply piping, fluid drain piping, and combinations thereof. A controller may be provided for monitoring a status of the MEP system and, optionally with a user interface providing user access to the controller. The interface may be a physical keyboard, touch screen display, local software application, downloadable software application accessible via smartphone or other smart device, etc.

In various embodiments, the base may also include lifting points, forklift cavities, and/or wheels to facilitate transport, installation, and/or removal of the base in the temporary habitable enclosure, especially important when traversing rough and uneven ground conditions. The base can have various wheel configurations, such as concealed wheels (e.g., internal to the perimeter of the footprint of the frame of the base) that can be extended vertically to engage the ground to permit rolling/positioning of the base and, once the base is located or positioned as desired, the concealed wheels can be retracted so that the base rests on the ground directly or with leveling pads. Any suitable mechanism (e.g., mechanical cam, hydraulic pump ram, etc.) can be used to individually, in pairs, or collectively deploy and retract the wheels. In one embodiment, the wheel deployment and retraction mechanism is only actuated when movement of the base is required. Alternatively, connecting points (e.g., for connecting the base to another base(s), grid(s), a supply or discharge system/network, and the like) may be included.

The base MEP system may include an electrical energy collection system, an electrical energy distribution system, an electrical energy storage system, an electrical energy conditioning/inverter system, a water filtration system, a rainwater collection system, a potable water system, a grey water system, a black water system, an HVAC system, and/or a data/communications system. In other applications, it may also include one or more of a distribution board/interface, a fire detection and alarm system, a fire-fighting system, a security system, a voice and data system, transformer substations, and emergency power generator connections.

In various embodiments, the plumbing device(s) may include a bidet, a shower, a sink, a toilet, and/or a urinal. The cooking device(s) may include an oven, a microwave oven, a grill, a refrigerator, an all-in-one cooker, and/or a stove. The lighting device(s) may include a rotatable lamp, a nightlight, and/or a spotlight. The ambient environment regulating device(s) may include an air conditioner, a boiler, a dehumidifier, a furnace, a heater, a fan, air purifier, heated blanket, and/or an HVAC system, power supply sockets/connectors, and/or components thereof.

According to another aspect, embodiments of the invention feature a method of manufacturing a base adapted for use in a temporary habitable enclosure to provide utilities to occupants thereof. In one embodiment, the method includes the steps of manufacturing a housing forming a plurality of compartments, wherein the housing encloses and provides access to the compartments, installing in each compartment at least a portion of an MEP system, an appliance, or a fixture, and installing an integrated network in the housing interconnecting the MEP systems with any fixtures and appliances. One or more of the fixtures, appliances, devices, and components can be an original built in or customized appliance or fixture or one that is commercially available or, as appropriate, may be modified or custom designed to meet the particular needs of any application for the base.

According to yet another aspect, embodiments of the invention feature a method of using a base in a temporary habitable enclosure to provide utilities to occupants thereof, the base including a housing forming a plurality of compartments, each compartment containing at least a portion of an MEP system, an appliance, or a fixture, wherein the housing encloses and provides access to the compartments, and an integrated network interconnecting the MEP systems with the fixtures, and the appliances. The appliances or fixtures may be point-of-use or original customized appliances and fixtures. According to this method, the steps include placing the base in an interior of the temporary habitable enclosure and deploying and using at least one MEP system, fixture or appliance of the base.

Such use may include a base that can be used with or without a fixture or appliance. For example, the MEP system can be connected to one or more of: a solar panel system (e.g., to charge the battery), a battery charger, a generator, and/or a power supply grid, and the like. A water tank can be filled manually or connected to a water supply tank or water supply grid. Used water can be discharged manually or connected to a drainage tank or a drainage grid. Grey water can be reused within the base for single-cycle (i.e., flushing a WC) or can be collected in the base water collection tank for manual discharge. Alternatively, it can be connected to a grey water discharge exterior tank or grid system. Blackwater can be reused within the base for single-cycle (e.g., biogas, generating electricity, etc.). Alternatively, blackwater may be discharged manually as bio-elements (e.g., for farming), and/or can be collected in the base blackwater collection tank for manual discharge. Alternatively, the base can be connected to a blackwater discharge exterior tank and/or a grid system.

These and other features, along with advantages of the embodiments of the present invention herein disclosed, will become more apparent through reference to the following description, the accompanying drawings, and the claims. Furthermore, it is to be understood that the features of the various embodiments described herein, including the dimensions and capacity of the base and its integrated parts, are not mutually exclusive and can exist in various combinations and permutations.

### BRIEF DESCRIPTION OF THE DRAWINGS

In the drawings, like reference characters and annotations generally refer to the same parts throughout the different views, however, for clarity not every component may be labeled in every drawing. Also, the drawings are not necessarily to scale, emphasis instead generally being placed upon illustrating certain principles of the invention. Where dimensions are shown, numerical values are in millimeters (mm), unless otherwise noted. In the following description, various embodiments of the present invention are described with reference to the following drawings, in which:

FIG. 1 is a schematic front perspective view of a habitable enclosure base on six wheels according to one embodiment of the invention;

FIG. 2 depicts a schematic front perspective view of the base of FIG. 1 with various fixtures and appliances in an open state according to some embodiments of the invention;

FIG. 3 includes schematic front and right side views of one embodiment of the base, depicting the arrangement and cooperation of the various fixtures and appliances;

FIGS. 4-6 are schematic rear perspective views of the base according to one embodiment of the invention;

FIG. 7 includes schematic rear and left side views of one embodiment of the base, depicting the arrangement and cooperation of the various fixtures and appliances;

FIG. 8 is a plan section view of a lower elevation of the base, depicting the WC in a stowed position, with the deployment swing path depicted in dashed line;

FIGS. 9-12 depict, in schematic rear perspective views, the sequencing of deployment of the shower components;

FIG. 13 is a plan section view of a next elevation of the base, above that depicted in FIG. 8;

FIGS. 14-15 depict the sink pivoted for use on the front and rear sides of the base, respectively;

FIG. 16 depicts an access door on the left side of the base forming a ramp to facilitate removal and installation of a large water tank;

FIG. 17 is a plan section view of the next elevation of the base, above that depicted in FIG. 13;

FIG. 18 depicts access from the side of the base to the electrical compartment;

FIG. 19 depicts a view into the central MEP shaft access;

FIG. 20 depicts access to the grey water tank for removal/replacement via a hinged door in the front of the base;

FIG. 21 depicts access to the sweet water tank and filter for removal/replacement via a hinged door in the left side of the base;

FIG. 22 is a plan section view of the next elevation of the base, above that depicted in FIG. 17;

FIG. 23 depicts the access doors on the front of the base to the filters and pumps, above the access door for the grey water tank;

FIG. 24 is a plan section view of the next elevation of the base, above that depicted in FIG. 22;

FIG. 25 depicts a flexible solar energy collector mat associated with the base;

FIG. 26 is a plan section view of the next elevation of the base, above that depicted in FIG. 24;

FIG. 27 depicts a rear view of the base with the rear lamp partially deployed;

FIG. 28 depicts the uppermost elevation of the top of the base;

FIG. 29 is a rear section view taken along line 1-A104 of FIG. 8;

FIG. 30 is a center side section view taken along line 2-A104 of FIG. 8;

FIGS. 31-32 are, respectively, annotated top perspective views of the rear and the front of the base with certain components deployed;

FIGS. 33-34 are, respectively, annotated top perspective and rear phantom views of the base from the rear, focusing on certain of the electrical system components of the base;

FIGS. 35-36 are, respectively, annotated top perspective and rear phantom views of the base from the rear, focusing on certain of the plumbing system components of the base;

FIGS. 37-38 are front perspective views of the base with certain associated water compartment component panels and the MEP access panel open;

FIGS. 39-40 are, respectively, annotated top perspective and rear phantom views of the base from the rear, focusing on the solar system components;

FIG. 41 depicts a side view of the base with the electrical access panel door open;

FIGS. 42-43 are, respectively, annotated top perspective and rear phantom views of the base from the rear, focusing on certain of the HVAC components of the base;

FIGS. 44-45 are, respectively, annotated top perspective and rear phantom views of the base from the rear, focusing on the grey water system of the base;

FIGS. 46-47 are, respectively, annotated top perspective and rear phantom views of the base from the rear, focusing on certain of the water supply system components of the base;

FIG. 48 is a plan section view of a lower elevation of a mini-base, according to another embodiment of the invention;

FIG. 49 is a plan section view of a next elevation of the mini-base, above that depicted in FIG. 48;

FIG. 50 is a plan section view of the next elevation of the mini-base, above that depicted in FIG. 49;

FIG. 51 is a plan section view of the next elevation of the mini-base, above that depicted in FIG. 50;

FIG. 52 depicts the uppermost elevation of the top of the mini-base;

FIGS. 53-54 include, respectively, schematic rear and right side views of one embodiment of the mini-base, depicting the arrangement and cooperation of the various access doors and compartments;

FIGS. 55-56 include, respectively, schematic front and left side views of one embodiment of the mini-base, depicting the arrangement and cooperation of the various access doors and compartments;

FIG. 57 is a front section view taken along line 1-A104 of FIG. 48;

FIG. 58 is an off-center side section view taken along line 2-A104 of FIG. 48;

FIG. 59 is a rear section view taken along line 3-A104 of FIG. 48;

FIG. 60 is another off-center side section view taken along line 4-A104 of FIG. 48;

FIG. 61 is an annotated top perspective view of the front of the mini-base with certain components deployed;

FIGS. 62-63 are annotated top perspective views of the rear of the mini-base with certain components alternatively deployed;

FIG. 64 is a top plan view of the mini-base with the shower tray deployed;

FIG. 65 depicts an off-center side section view taken along line 2-A106 of FIG. 64;

FIG. 66 depicts an enlarged view of the shower drain at detail 3-A106 of FIG. 65;

FIG. 67 depicts a rear side view of the mini-base showing the shower tray leg locations;

FIGS. 68-69 are annotated enlarged side section views of an adjustable shower leg in a stowed position and a deployed position, respectively;

FIGS. 70-71 are annotated enlarged perspective views of a sink with a pull out faucet in a stowed position and a deployed position, respectively;

FIGS. 72-73 are annotated end views of a mini-base having extendible wheel axles with the wheels in a retracted or closed position and also in an extended or open position, respectively;

FIGS. 74-75 are annotated rear perspective views of the mini-base having extendible wheel axles with the wheels in the retracted or closed position and also in the extended or open position, respectively;

FIG. 76 is a schematic front view of the mini-base having lifting jacks to elevate the mini-base;

FIGS. 77-79 are, respectively, annotated top perspective, enlarged top, and front phantom views of the mini-base from the front, focusing on certain of the electrical system components of the mini-base;

FIGS. 80-81 are, respectively, annotated top perspective and front phantom views of the mini-base from the front, focusing on certain of the HVAC components of the mini-base; and

FIGS. 82-83 are, respectively, annotated top perspective and front phantom views of the mini-base 100′ from the front, focusing on certain of the plumbing system components of the mini-base 100′.

### DETAILED DESCRIPTION

In broad overview, embodiments of the present invention feature a new approach to providing important basic services to temporarily displaced individuals living in temporary enclosures, or non-enclosed areas, or persons living off the grid. By providing a portable MEP system suitable for use by a family or small group of individuals cohabitating in a tent, shelter, or other temporary enclosure, or in a non-enclosed area, some semblance of normalcy and control can be afforded, greatly supporting the health and well-being of the individuals during an admittedly stressful period that can and unfortunately does extend for months in some instances. According to one embodiment, a base is adapted for use in the temporary habitable enclosure to provide comfort and help to meet the basic needs of the individuals by providing lighting, heating, cooling, electrical power, water, cooking, showering, washing, and toilet facilities in a highly compact, functional and portable structure. Modularity and flexibility of the configuration of the base makes the base especially well adapted to accommodate temporary habitable enclosures of various sizes and MEP system requirements. This approach also permits the base to change over time, as necessary or desirable, to accommodate the changing needs of the temporary habitable enclosure and its inhabitants.

Although embodiments of this invention will be described in terms of use of the base in conjunction with a temporary habitable enclosure, those of ordinary skill can appreciate that the described base may also be used with or in a non-enclosed area, i.e., in some instances, non-enclosed areas may be used instead of enclosed tents, shelters, and the like.

One or more of the fixtures, appliances, devices, and components used in combination with the base can be an original built in or customized appliance or fixture or one that is commercially available or, as appropriate, may be modified or custom designed to meet the particular needs of any application for the base.

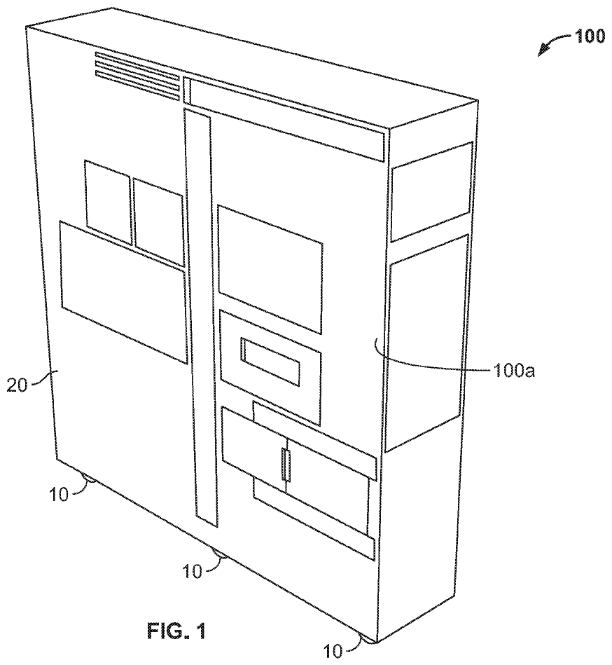

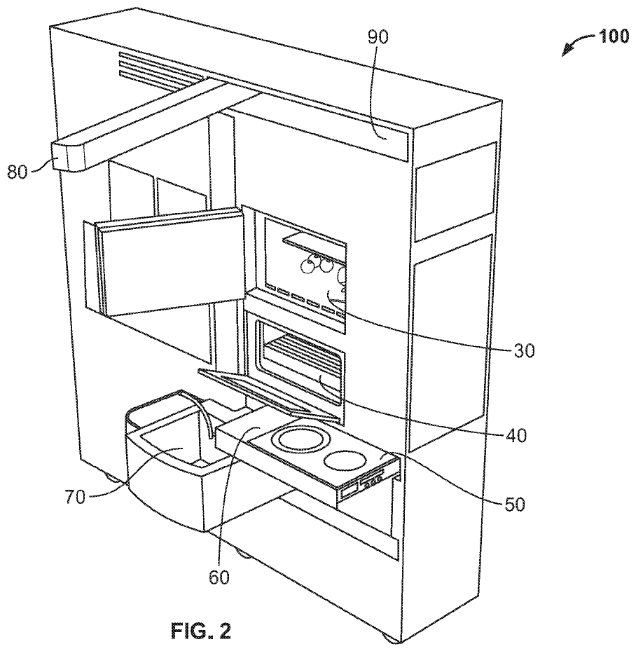

FIG. 1 is a schematic front perspective view of a habitable enclosure base 100 on six wheels 10 according to one embodiment of the invention; however, fewer or more wheels 10 can be provided, as warranted (e.g., two, three, four, etc.). The base 100 includes an external housing 20 and optionally an internal structural frame forming a plurality of compartments, each adapted to contain at least a portion of an MEP system, an appliance, or a fixture. The exterior of the housing 20 or optional external cladding in the form of removable panels, hinged doors, and the like provides access to the internals of the base 100, as well as to the appliances and fixtures. The housing 20 may also include ventilation systems, internal heat recovery systems, and the like. By way of example only, FIG. 2 depicts in a generally stacked arrangement: a small refrigerator 30 for storing perishable food, a compact oven and/or microwave (individually and collectively 40), a two-burner stove top or hot plate 50 with a food preparation area 60 (e.g., a working tray), as well as a sink 70 for washing and/or food preparation. A work light 80 swings out from a top portion 90 of the base 100 to illuminate this work zone and to provide general illumination for other purposes. As described below, the base 100 includes pivoting doors to provide access to internals and/or includes sliding or pivoting mounts to deploy the devices for use, while allowing the devices to be stowed when not in use, maintaining cleanliness and a small overall footprint of the base 100 when the fixtures and appliances are not in use.

In some embodiments, e.g., for mass production applications, a mold may be made using a new material that combines structural elements and building/finishing elements. It may be made of recycled elements that may be heavy duty environment/waterproof. The mold can have compartments that fit with specific mechanisms.

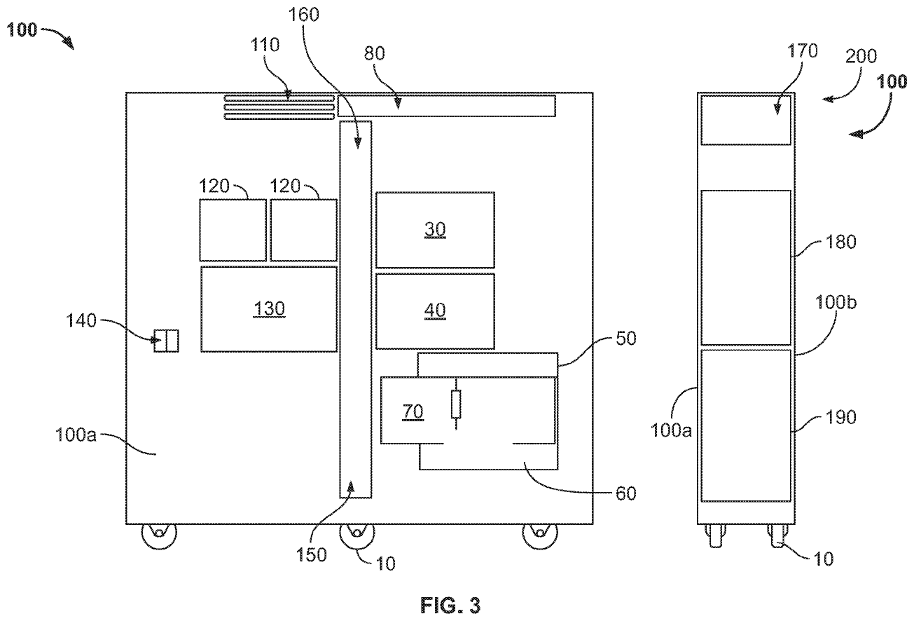

FIG. 3 includes schematic front and right side views of one embodiment of the base 100, depicting the arrangement and cooperation of the various fixtures and appliances. The front exterior 100a includes a vent grill 110 for the HVAC system along with the rotatable lamp arm 80 at the top of the base 100, as well as hinged access doors for water filters 120 and a grey water tank 130 along the left side. Also provided at a convenient height on the left is a faucet 140 for drawing potable fresh water or potable sweet (e.g., rain) water for drinking and cooking.

Generally centrally disposed is a hinged access door 150 to the central open shaft 160 of the base 100, through which many components of the integrated network interconnecting the MEP system pass, including piping, ducting, cabling, and the like. To the right of the shaft access door 150 is a cluster of food preparation fixtures and appliances including, in this embodiment, a refrigerator 30, an oven 40, a stove 50, a sink 70, and a working tray 60 for cutting, chopping and holding comestibles. The right side of the base 100 includes access doors for certain components of the solar power system 200, such as a compartment 170 for the storage batteries 175, and various water tank compartments 180, 190.

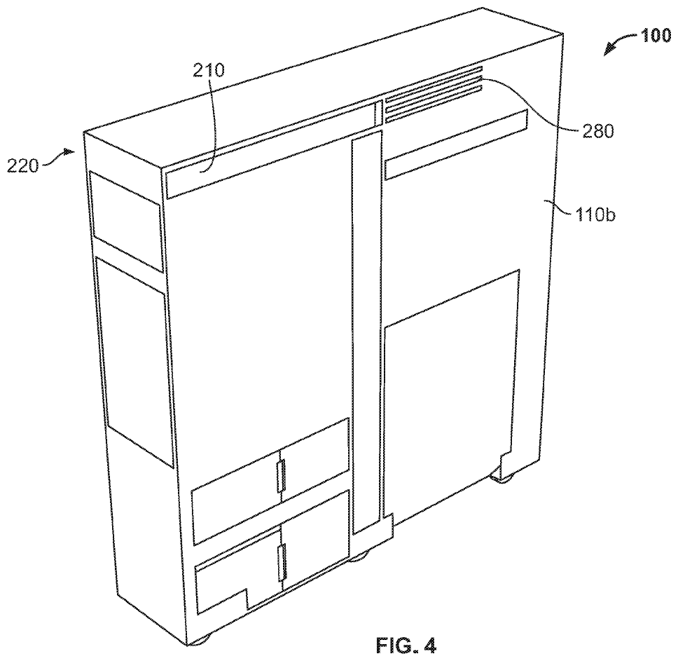

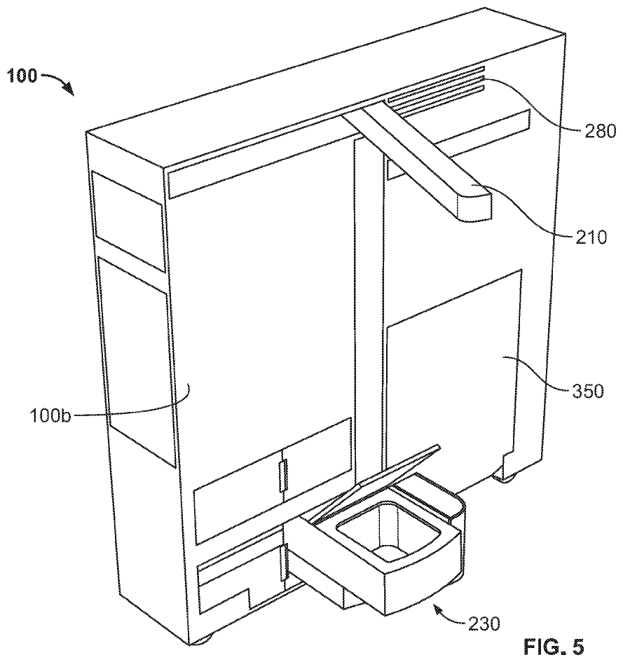

FIGS. 4-6 are schematic rear perspective views of the base 100 according to one embodiment of the invention. By way of example only, FIG. 5 depicts another work light (i.e., a rotatable lamp with an arm) 210 that swings out from a top portion 220 of the base 100 to illuminate this work zone and to provide general illumination for other purposes. Additionally, along a left bottom portion of the base 100, a toilet or WC 230 swings out. Referring to FIG. 6, along a right portion of the base 100, a shower pan 240 folds down and a collapsible shower curtain 250 can be extended between the pan 240 and a translating shower curtain holder 260 and shower head 270 that extend out from an upper portion of the base 100. The rear side 100b of the base 100 similarly includes pivoting doors to provide access to internals and/or includes sliding or pivoting mounts to deploy the devices for use, while allowing the devices to be stowed when not in use, maintaining cleanliness and a small overall footprint of the base 100 when the fixtures and appliances are not in use.

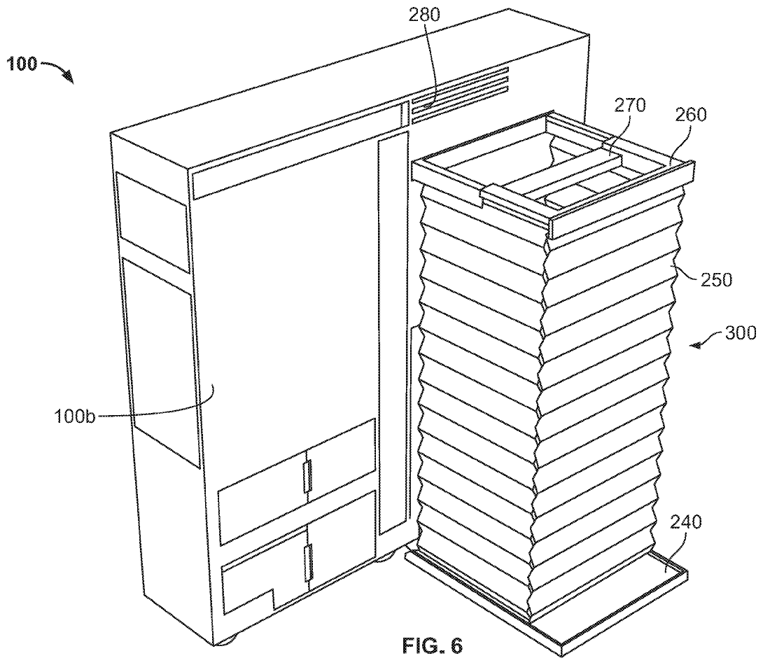

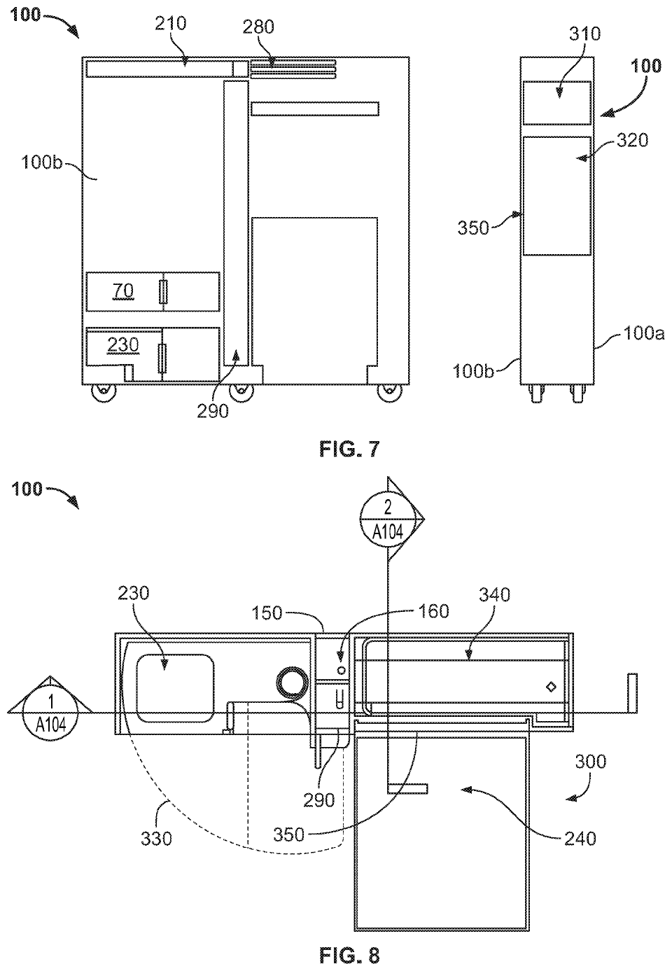

FIG. 7 includes schematic rear and left side views of one embodiment of the base 100, depicting the arrangement and cooperation of the various fixtures and appliances. The rear exterior 100b includes another vent grill 280 for the HVAC system along with the second rotatable lamp arm 210 at the top portion 220 of the base 100.

Generally centrally disposed is another hinged access door 290 to the central open shaft 160 of the base 100, through which many components of the integrated network interconnecting the MEP system pass, including piping, ducting, cabling, and the like. To the left of the shaft access door 290 is the sink 70, which is accessible to swing out of the front 100a and the rear 100b of the base 100. The sink 70 is located just above the WC 230. As mentioned above, the right side of the base 100 includes the fold down shower tray 240, as well as the extendible shower curtain holder 260 and shower head 270, creating with the shower curtain 250 a private, single person shower stall 300. The left side of the base 100 includes access doors for certain components of the HVAC unit 310, as well as various electrical components, including the controller 320 for the base 100.

The base 100 may include one or more ambient environment regulating device(s), such as the HVAC system, an air conditioner, a boiler, a dehumidifier, a furnace, a heater, a fan, an air purifier, a heated blanket, power supply sockets/connectors, and components thereof.

FIG. 8 is a plan section view of a lower elevation of the base 100, depicting the WC 230 in a stowed position, with the deployment swing path 330 depicted in dashed line. Referring also to FIG. 7, the large water tank 340 is stored in this lower portion, behind the wall 350 that forms a portion of the shower enclosure 300, when the shower tray 240 is deployed.

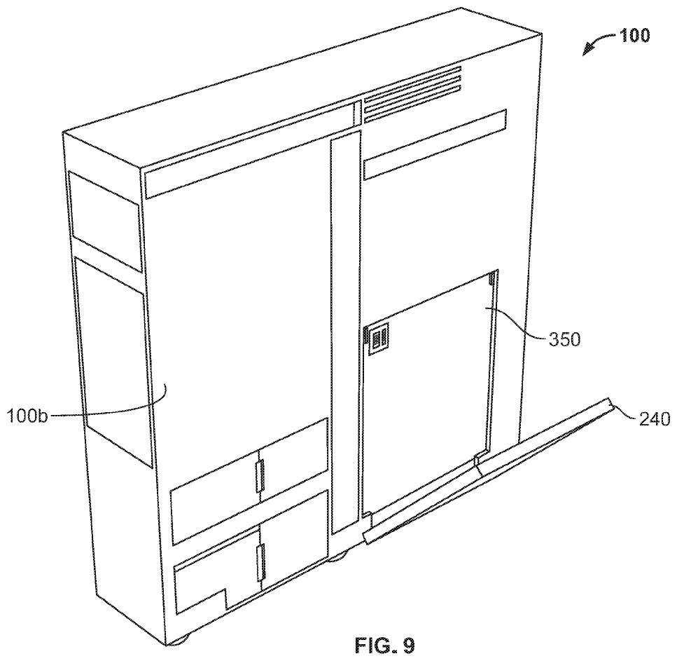

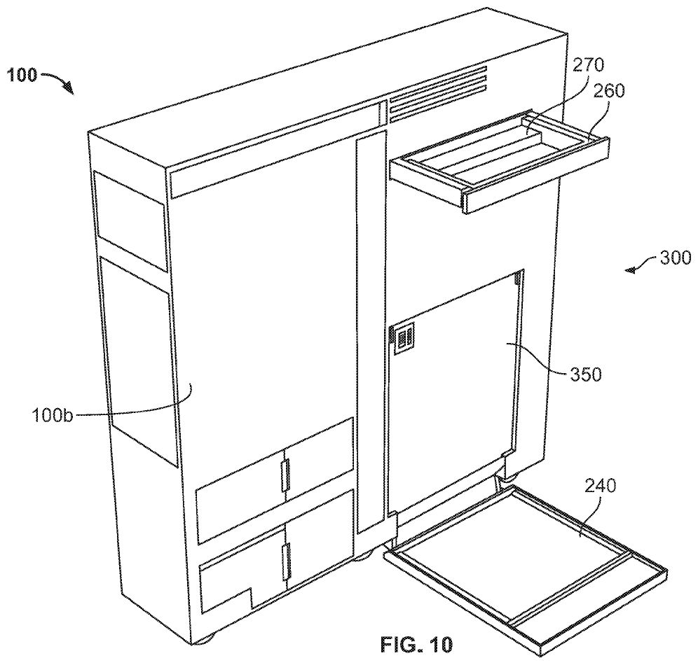

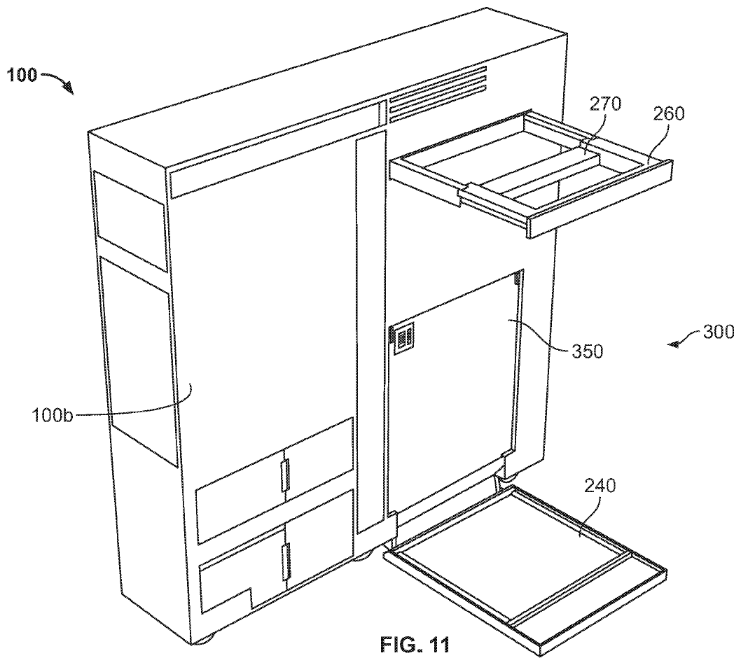

The sequencing of deployment of the shower components is depicted in schematic rear perspective views of FIGS. 9-12. More particularly, the shower tray 240 is folded down from the rear wall (FIG. 9) and the shower curtain holder 260 and shower head 270 are extended from an upper portion of the base 100 (FIGS. 10-11). The collapsible shower curtain 250 is then extended between the tray 240 and the holder 260 to substantially enclose the shower stall 300, both for privacy and to keep the shower water contained to the tray 240 (FIGS. 12 and 6). Referring also to FIG. 3, the shower water is pumped to the grey water tank 130 for non-potable reuse.

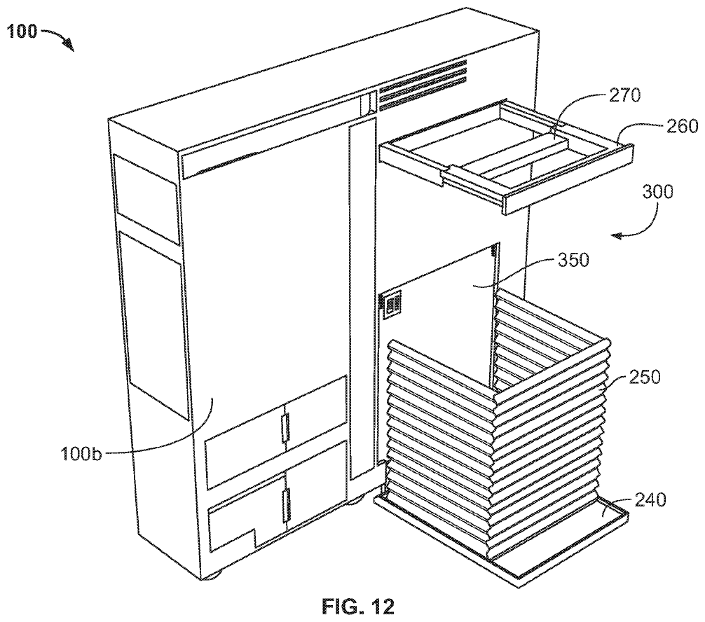

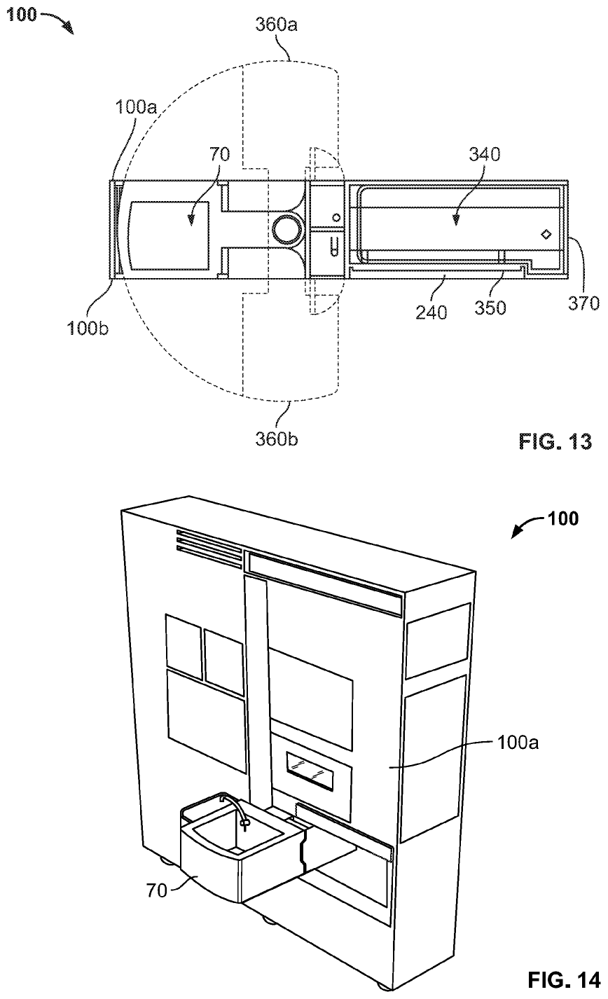

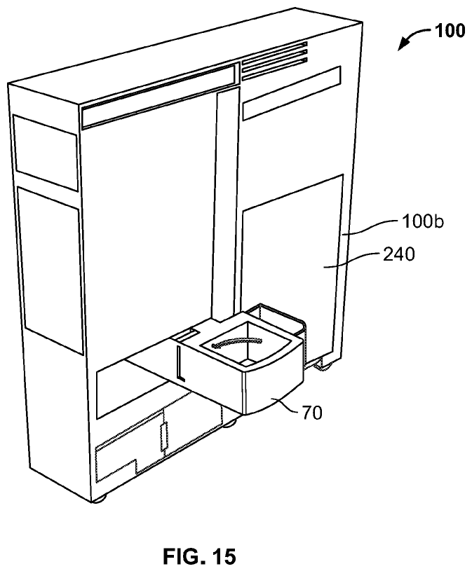

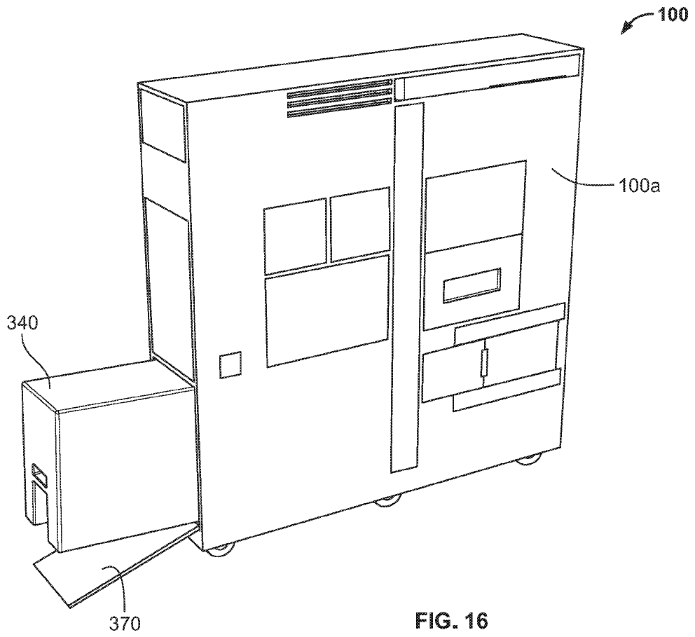

FIG. 13 is a plan section view of a next elevation of the base 100, above that depicted in FIG. 8, depicting the sink 70 in a stowed position. Notably, the sink 70 can be swung bi-directionally, so as to be accessible from both the front 100a and rear sides 100b of the base 100. The deployment swing paths 360a, 360b are depicted in dashed line. Accordingly, the sink 70 can be used alternatively for food preparation and personal hygiene. See FIGS. 14-15. The large water tank 340 stored in the lower portion, behind the wall 350 that forms a portion of the shower enclosure 300, extends up into this elevation. The access door 370 on the left side of the base 100 forms a ramp to facilitate removal and installation of this large water tank 340, as best seen in FIG. 16.

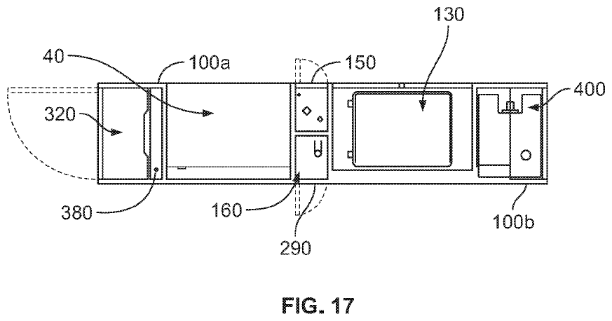

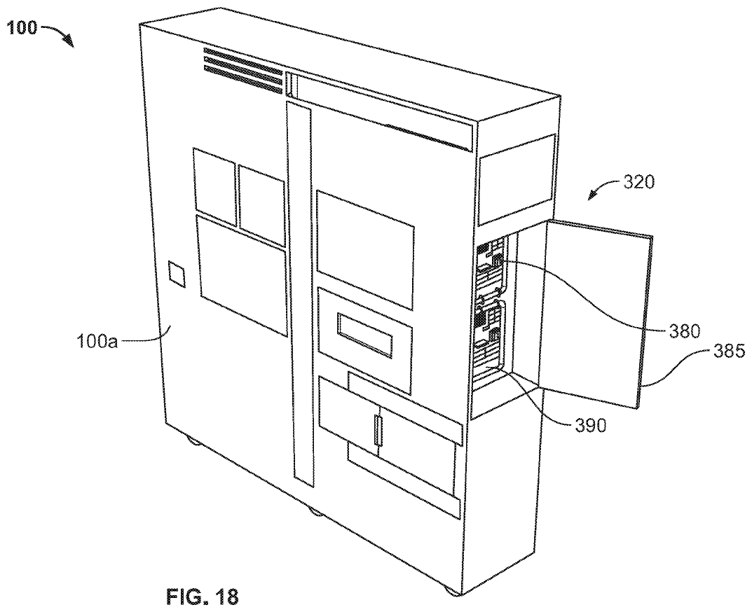

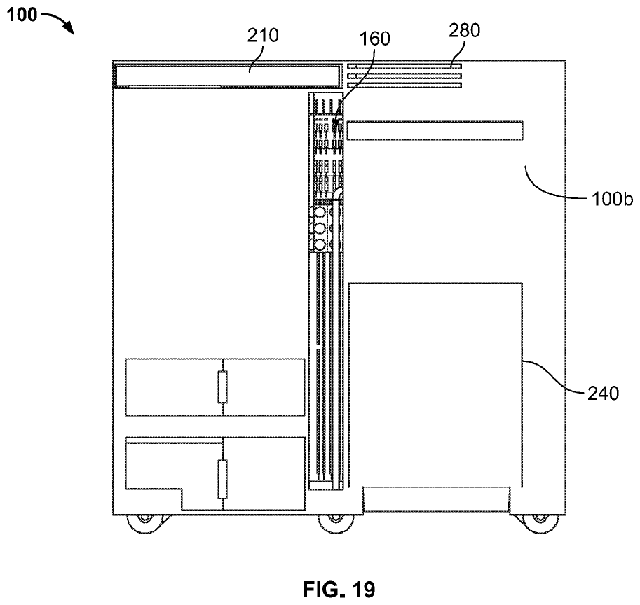

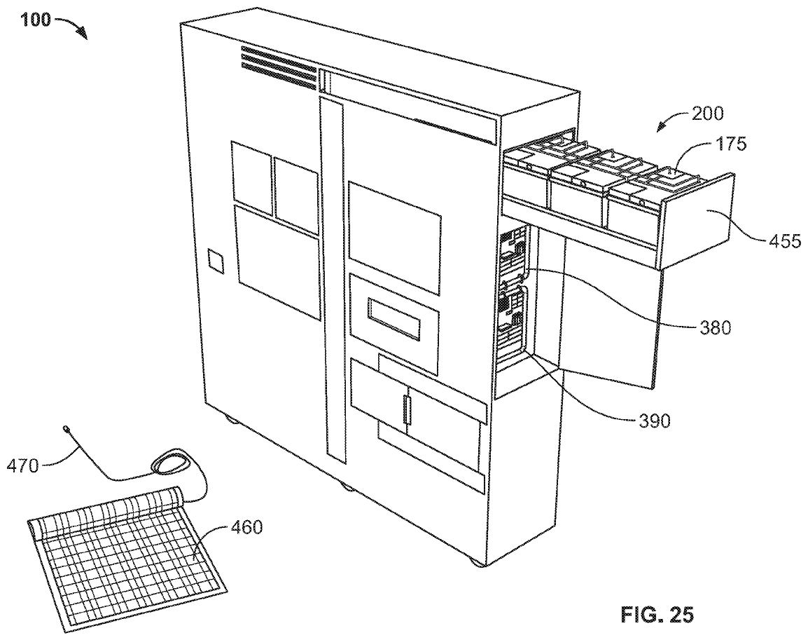

FIG. 17 is a plan section view of the next elevation of the base 100, above that depicted in FIG. 13. At this elevation, access is provided from the side of the base 100 to the electrical compartment 320 containing the controller 380 for the base 100, as well as the electrical or distribution board (DB) 390 (e.g., a panelboard, breaker panel, or electric panel). These components divide the electrical power feed from the solar batteries 175 (FIG. 25) (or optional external power supply) into subsidiary circuits, while providing a protective fuse or circuit breaker for each circuit in this common enclosure 320. See FIG. 18 for the side access, as well as FIG. 19 for a view into the central MEP shaft access 160.

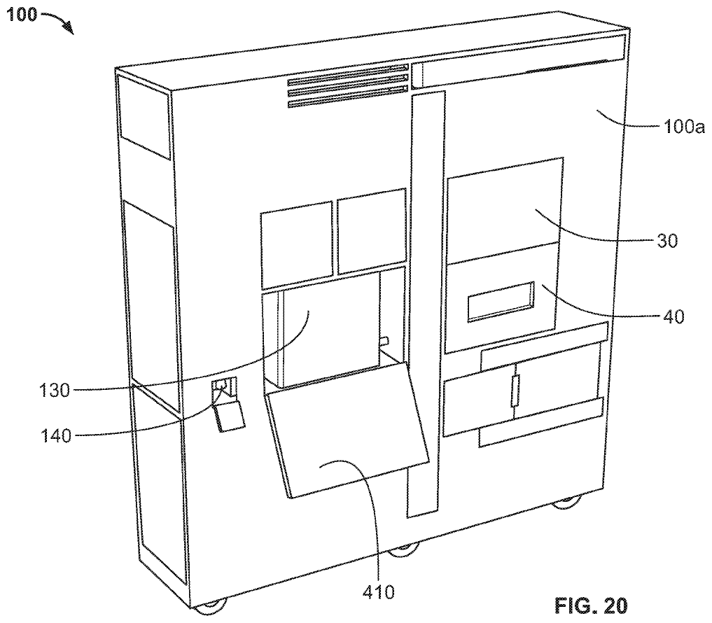

Also at this elevation are the oven 40, the grey water tank 130, and the sweet water tank and filter 400. The grey water tank 130 can be accessed for removal/replacement via a hinged door 410 in the front 100a of the base 100 (best seen in FIG. 20) and the sweet water tank and filter 400 can be accessed for removal/replacement via a hinged door 420 in the left side of the base 100 (best seen in FIG. 21).

In some applications, the base 100 may include a fire detection and alarm system, a fire-fighting system, a security system, a voice and data system, transformer substations, and/or emergency power generator connections.

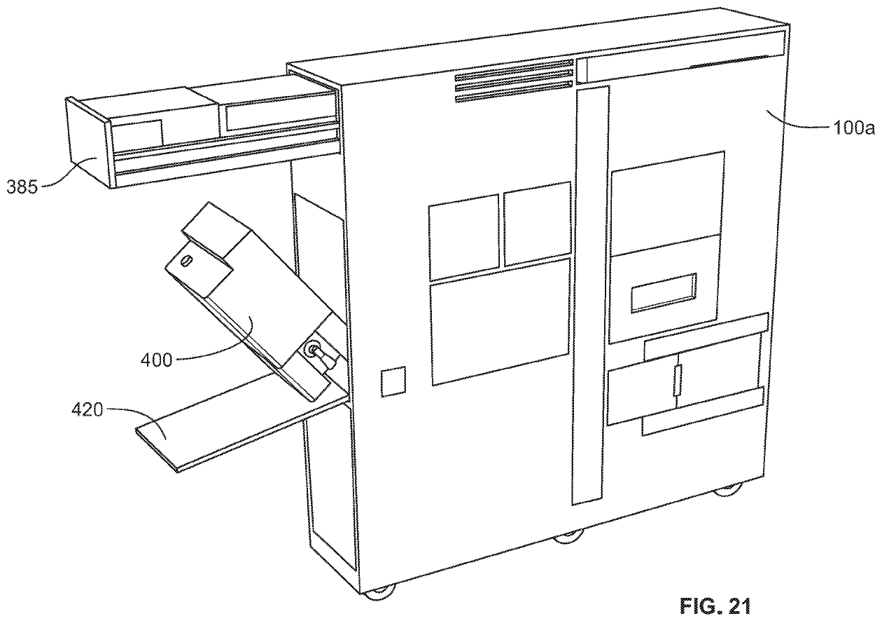

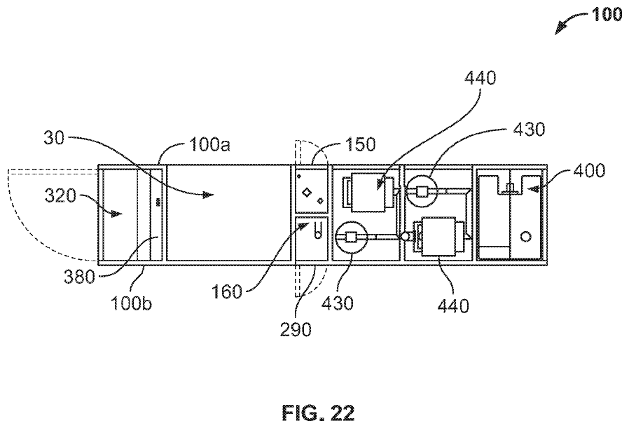

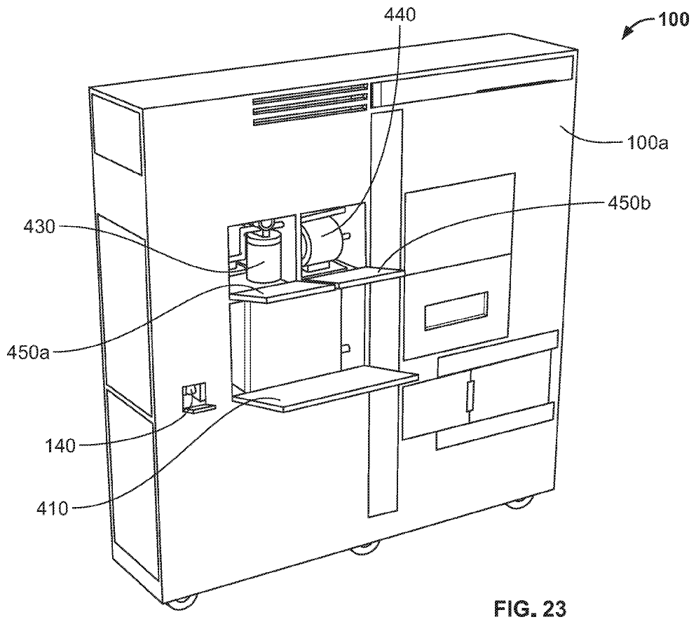

FIG. 22 is a plan section view of the next elevation of the base 100, above that depicted in FIG. 17. At this elevation, access continues to be provided from the side of the base 100 to the electrical compartment 320 containing the controller 380 for the base 100, as well as the electrical DB 390. The refrigerator 30 is located at this elevation, as are the water system filters 430 and pumps 440. See FIG. 23 for the access doors 450a, 450b on the front 100a of the base 100 to the filters 430 and pumps 440, above the access door 410 for the grey water tank 130. The sweet water tank 400 extends up into this elevation, as well.

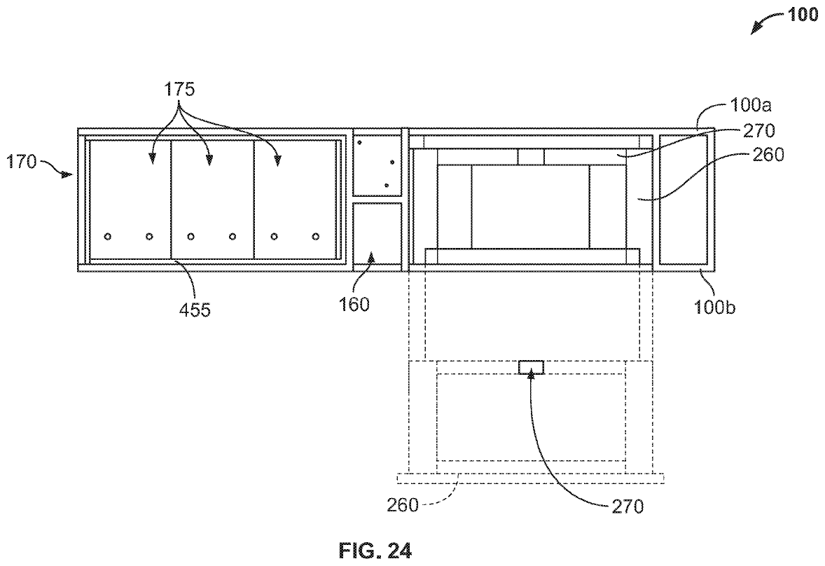

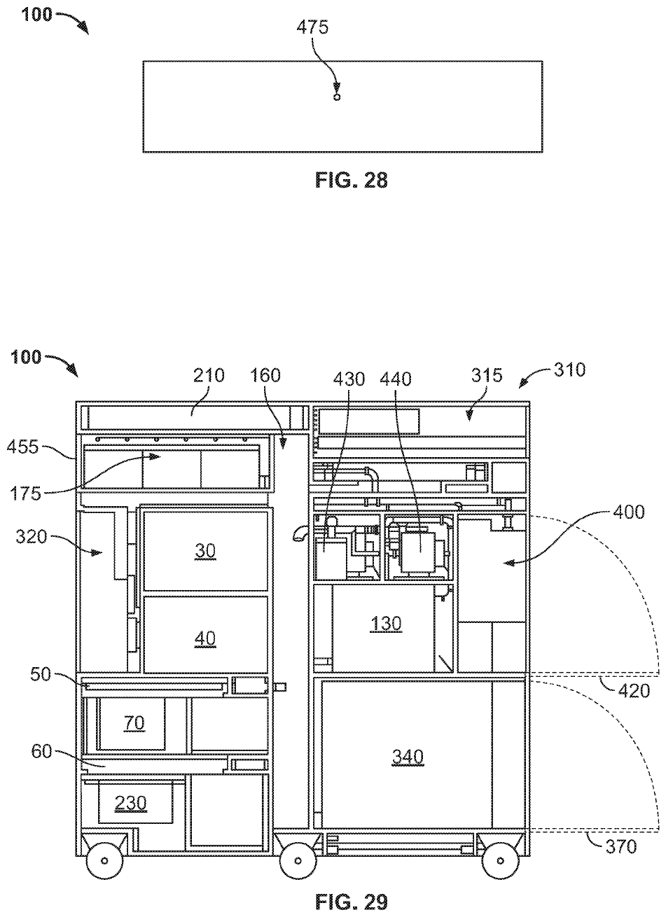

FIG. 24 is a plan section view of the next elevation of the base 100, above that depicted in FIG. 22. At this elevation, access (e.g., to the solar battery compartment 170) is provided to the plurality of batteries 175 disposed on a solar battery tray 455, that extends on slides from the side of the base 100. As depicted in FIG. 25, the base 100 includes a solar power system 200 that, in addition to the plurality of batteries 175 for storing solar-generated power and for providing stored power, includes a flexible solar energy collector mat 460, that can be laid on the ground outside the tent or shelter or, more preferably, hung from the side of or draped over the roof of the tent or shelter. A long cord 470 (FIG. 28) from the collection mat 460 plugs into a connector 475 on top of the base 100. In some implementations, the solar energy collector mat 460 generates current that may be stored in the batteries 175 (for later use) or may be used immediately, if needed. In some variations, the long cord 470 plugs into the connector 475 located on the top of the base 100, as shown in FIG. 28.

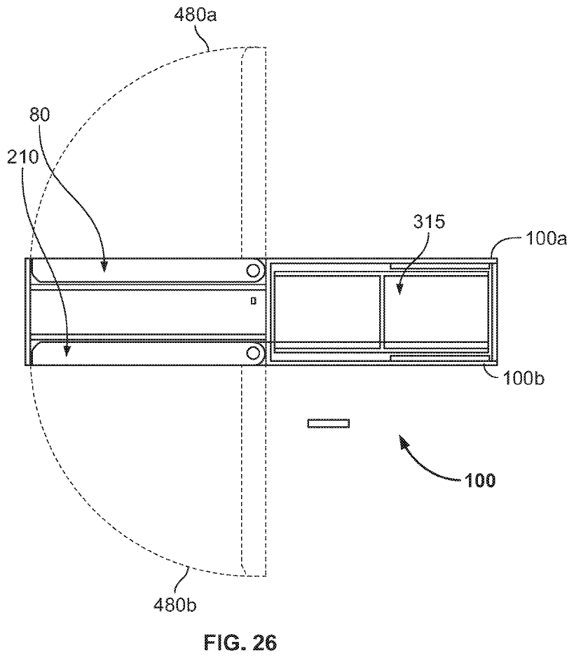

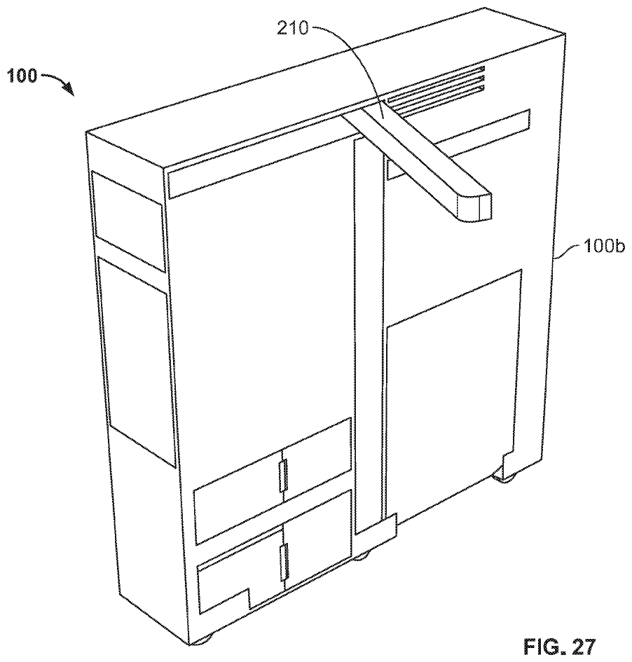

FIG. 26 is a plan section view of the elevation of the base 100, above that depicted in FIG. 24 and below that depicted in FIG. 28. At this elevation are the dual rotatable lamps 80, 210, with the 90-degree deployment swing paths 480a, 480b from the front 100a and rear faces 100b of the base 100 depicted in dashed line. See FIG. 27 with solely the rear lamp 210 partially deployed. Also depicted in the elevation view is the HVAC unit 315.

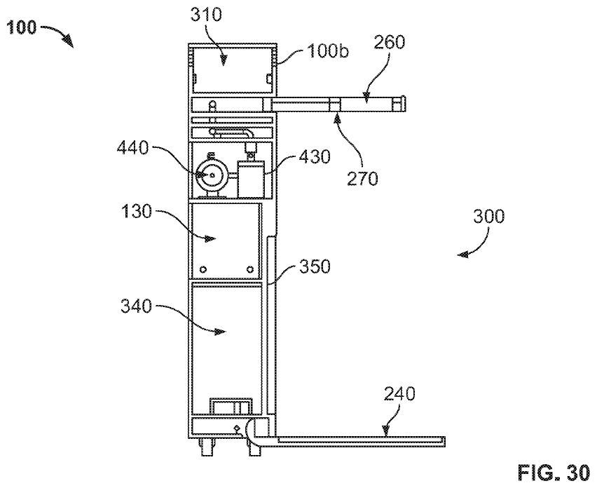

Turning now to FIGS. 29-30, the tight nesting of the various components, fixtures and appliances within the structure of the base can be appreciated. FIG. 29 is a rear section view taken along line 1-A104 of FIG. 8 and FIG. 30 is a center side section view taken along line 2-A104 of FIG. 8, for example. No space is wasted and all systems are carefully and thoughtfully arranged to provide convenient and efficient use of the base 100 by a broad variety of individuals, including young, old, healthy, and physically challenged, etc. And, as can be readily appreciated by those skilled in the art, while this arrangement provides many benefits, inclusion of additional or alternative systems, fixtures, appliances, and functionality are contemplated.

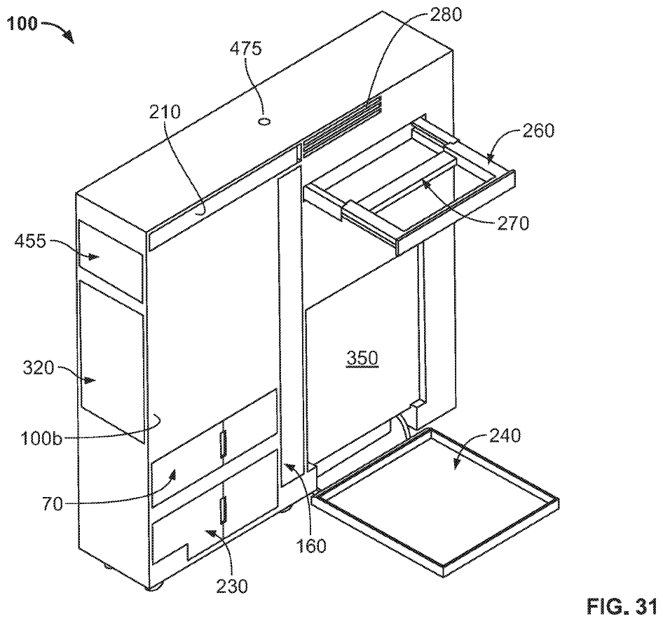

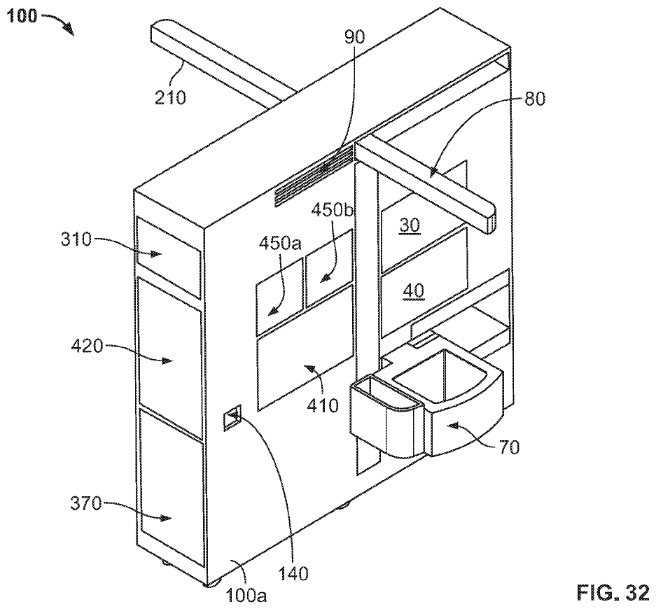

FIGS. 31-32 are, respectively, annotated top perspective views of the rear 100b and the front 100a of the base 100 with certain components deployed. In FIG. 31, portions of the shower (e.g., the shower pan 240, and the shower curtain holder 260 and shower head 270) are deployed; whereas, in FIG. 32, solely the lamps 80, 210 and the sink 70 are deployed. All other fixtures and appliances remain stowed.

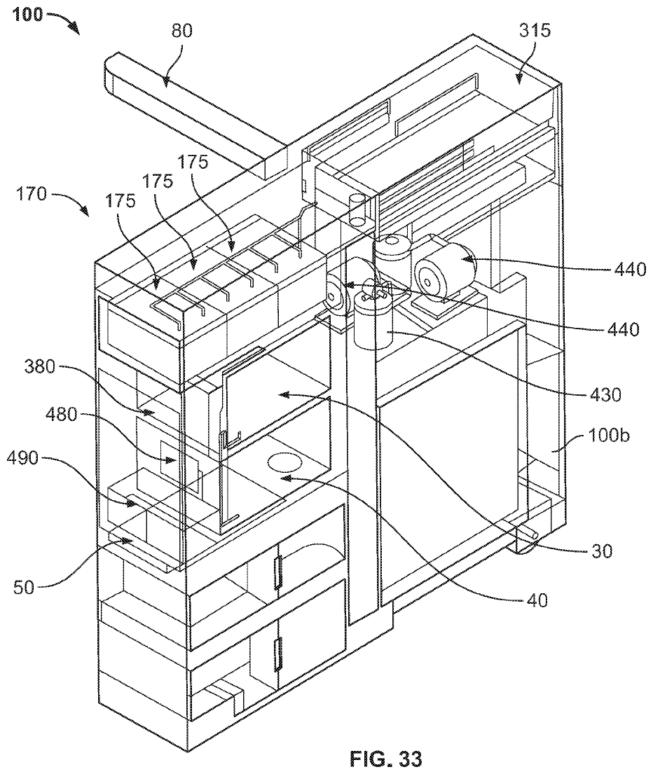

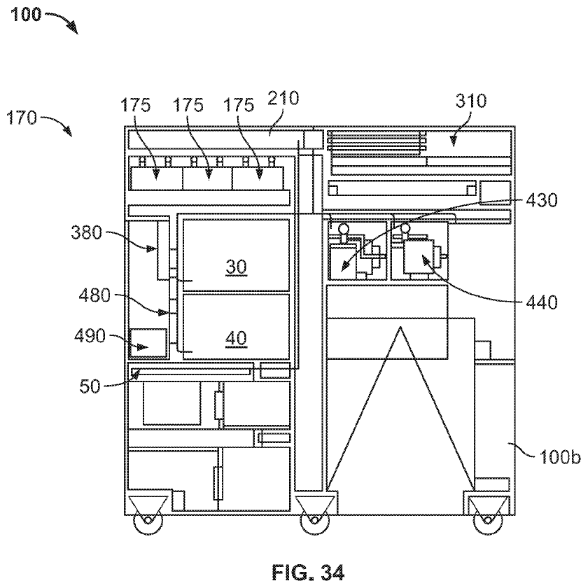

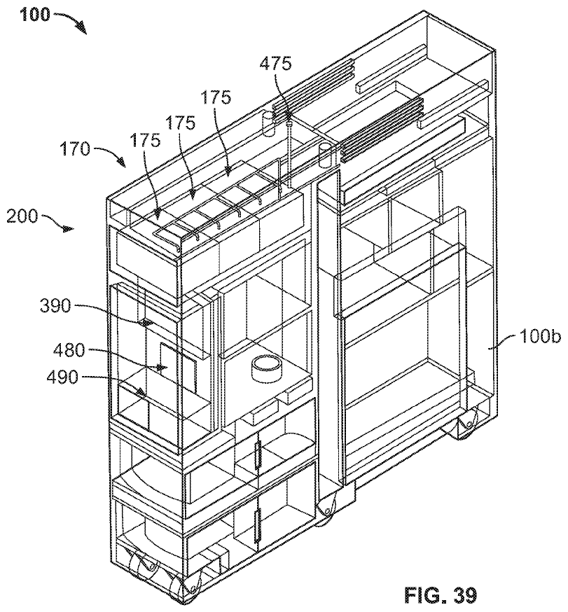

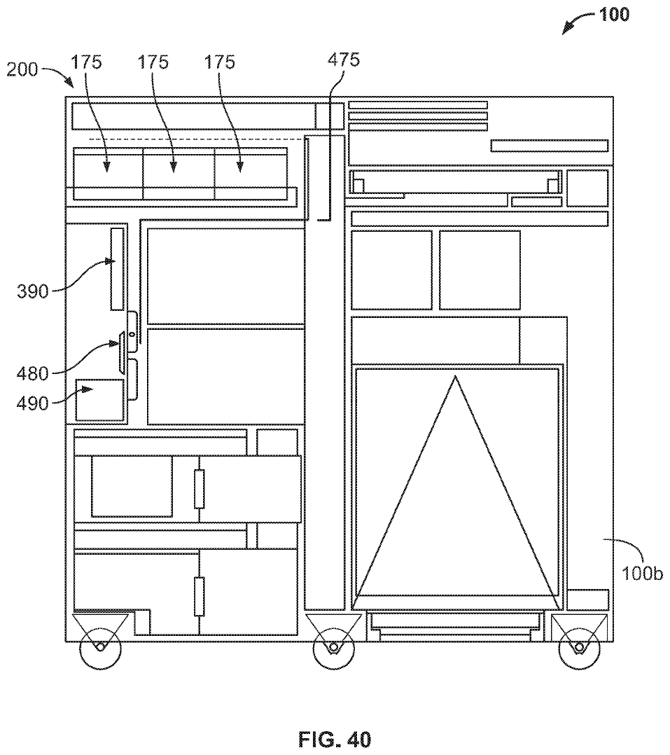

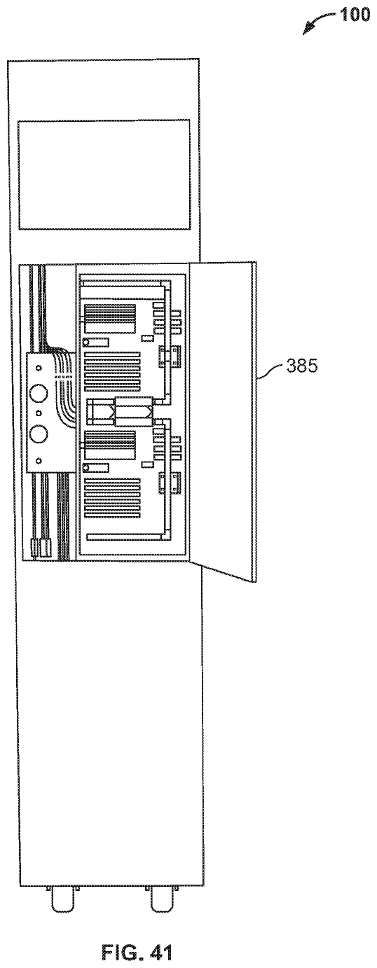

FIGS. 33-34 are, respectively, annotated top perspective and rear phantom views of the base 100 from the rear 100b, focusing on certain of the electrical system components. The base MEP system may include an electrical energy collection system, an electrical energy distribution system, an electrical energy storage system, an electrical energy conditioning/inverter system, a water filtration system, a rainwater collection system, a potable water system, a grey water system, a black water system, an HVAC system, and/or a data/communications system. In other applications, it may also include one or more of a distribution board/interface, a fire detection and alarm system, a fire-fighting system, a security system, a voice and data system, transformer substations, and emergency power generator connections. For example, the figures FIGS. 33-34 depict, among other things, the solar (e.g., storage) batteries 175 and associated cabling to the electrically powered elements, such as the refrigerator 30, oven 40, stove 50, and water pumps 440. Also depicted in FIGS. 33-34 is the arrangement of the electrical DB controller 390, the solar system charger controller 480, and a power inverter 490 to convert direct current (DC) battery power to alternating current (AC). For the solar specific components and associated cabling, see also FIGS. 39-40 for, respectively, annotated top perspective and rear phantom views of the base 100 from the rear 100b, focusing on the solar system components 200. See also FIG. 41 for a side view with the electrical access panel door 385 open.

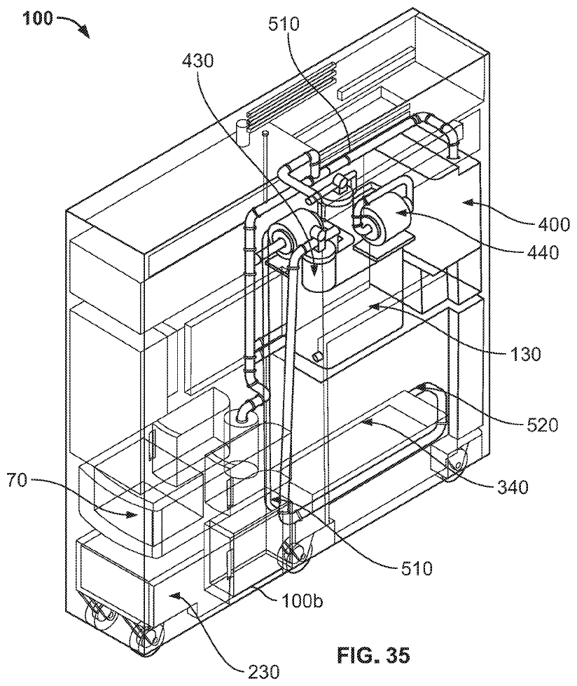

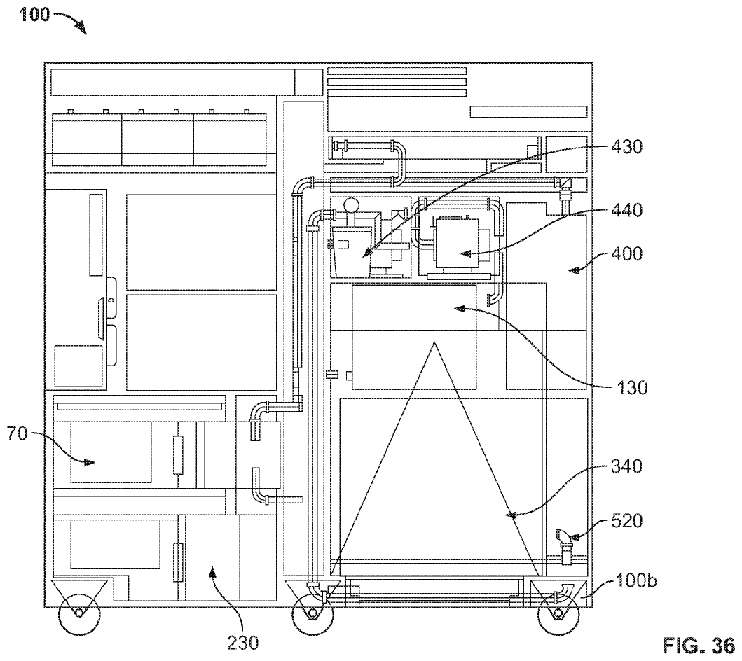

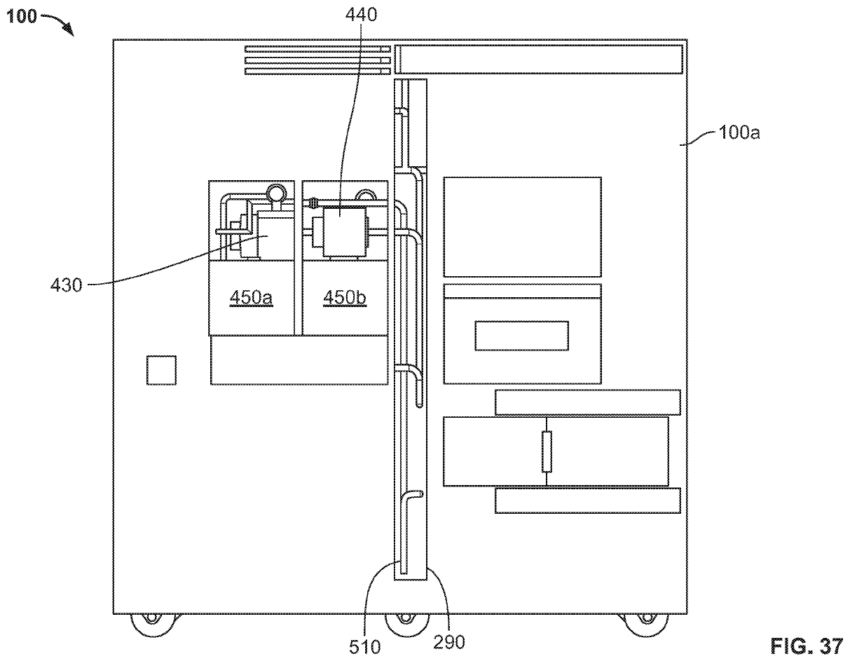

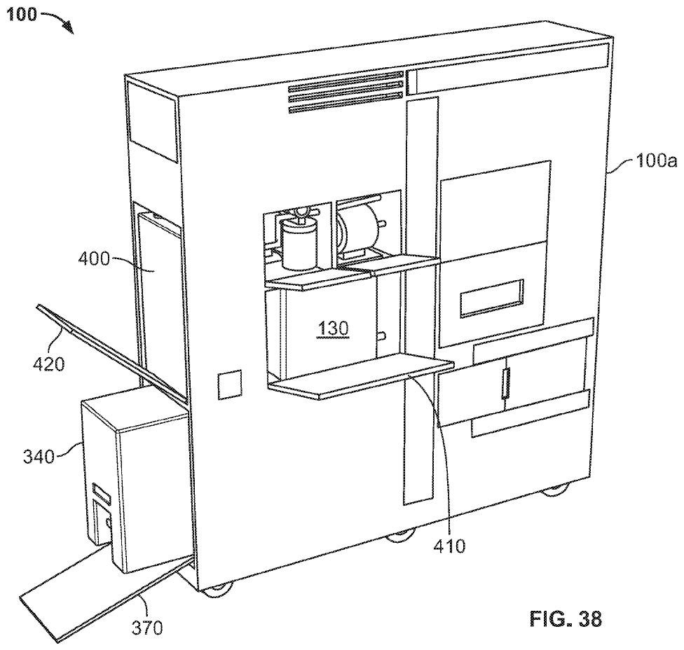

FIGS. 35-36 are, respectively, annotated top perspective and rear phantom views of the base 100 from the rear 100b, focusing on certain of the plumbing system components 500. For example, these figures depict, among other things, the large lower water tank 340, the grey water tank 130, the sweet water tank 400, the water filters 430, and pumps 440, along with some of the associated supply and drain piping 510 to connect these components to the water usage fixtures, such as the sink 70, as well as a hydraulic connection 520 to connect the plumbing system components 500 to an external water source. See also FIGS. 37-38 for front perspective views of the base 100 with certain associated water compartment component panels 410, 450a, 450b and the MEP access panel 290 open.

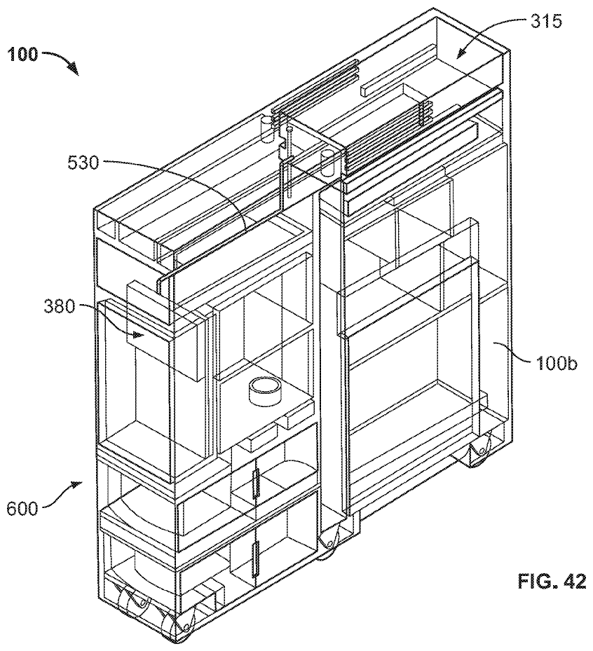

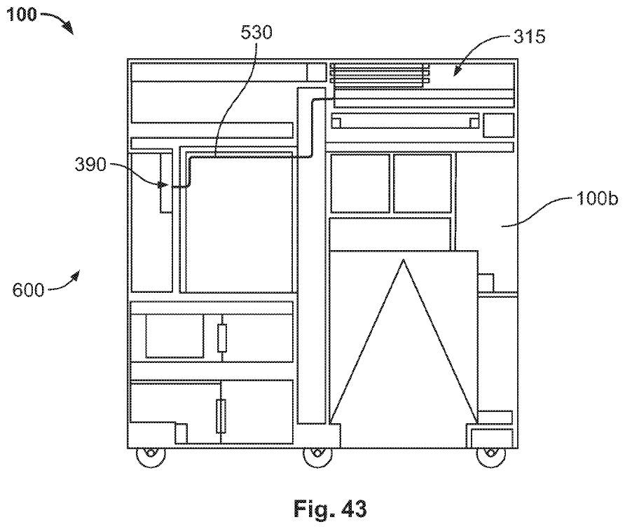

FIGS. 42-43 are, respectively, annotated top perspective and rear phantom views of the base 100 from the rear 100b, focusing on certain of the HVAC components 600, including the HVAC unit 315 located at the top of the base 100 and its interconnection 530 with the electrical DB controller 390.

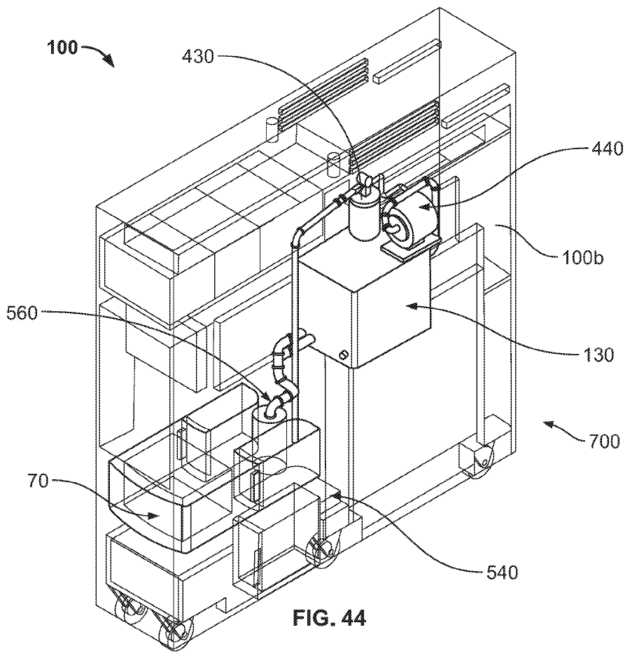

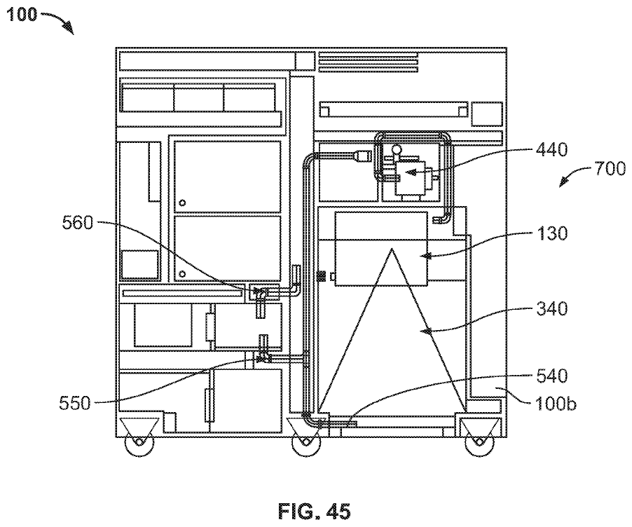

FIGS. 44-45 are, respectively, annotated top perspective and rear phantom views of the base 100 from the rear 100b, focusing on the grey water system 700. For example, these figures depict, among other things, sourcing grey water collected from the sink drain 550 and from the shower tray drain 540. More specifically, the collected grey water may be filtered and pumped, e.g., using the filters 430 and pumps 440, from the shower tray drain 540 and/or from the sink drain 550 into the grey water tank 130, where the recycled water can be used, for example, at the sink 70, e.g., via a grey water conduit 560.

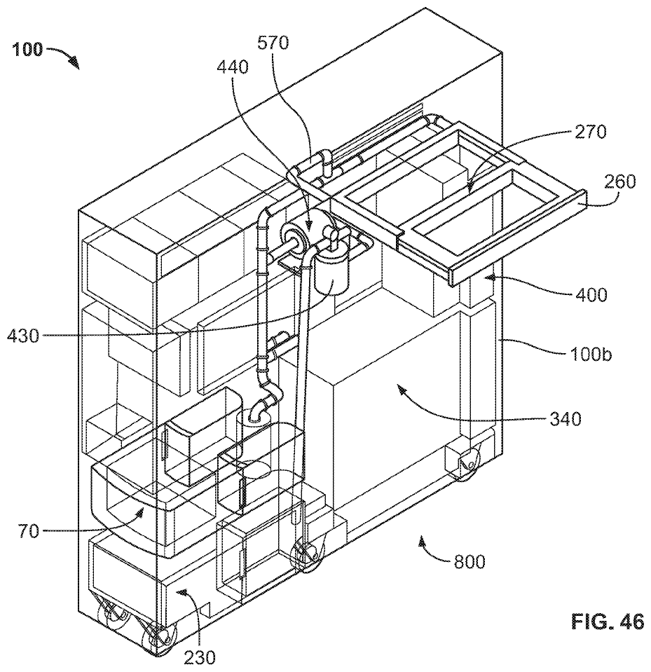

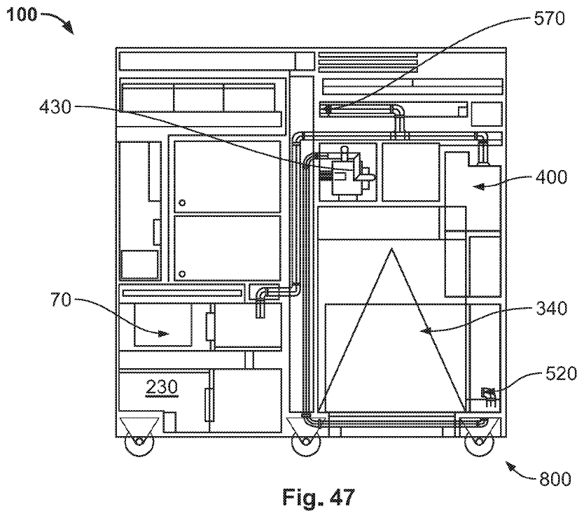

FIGS. 46-47 are, respectively, annotated top perspective and rear phantom views of the base 100 from the rear 100b, focusing on certain of the water supply system components 800. For example, these figures depict, among other things, the large water tank 340 stored in the lower portion of the base 100. Water is pumped and filtered from the large tank 340, e.g., using the filters 430 and pumps 440, for subsequent storage and secondary filtering when dispensed from the sweet water tank 400. Filtered water is also available for showering, with the shower head 270 connected to the pressurized source with a flexible hose 570 located along the shower curtain support 260. The WC 230 is a wholly separate system, isolated from the water supply system 800 and outfitted with a removable black water compartment, to prevent cross-contamination of other components and systems in the base.

Having fully described this embodiment of the invention, it will be apparent to those of ordinary skill in the art that other embodiments incorporating the concepts disclosed herein may be used without departing from the spirit and scope of the invention. For example, while this relatively large base 100, having a stowed overall size of about 2 m×2 m×0.5 m, may be suitable for use at many encampments, there is a need for an even smaller, more compact version of the base 100′, more suitable for smaller tents or shelters and/or deployment in more remote areas, yet still providing much of the same functionality.

Accordingly, another embodiment of the invention may be a more modestly sized base 100′, having a stowed size of about 2 m×1.3 m×0.5 m. This reduced-size base or mini-base 100′ may be particularly well-suited for use in smaller tents or shelters, with access openings of no more than about 1.5 m in height, to facilitate delivery and installation of the mini-base 100′ by wheeling the mini-base 100′ into place through the access door opening after the tent or shelter is erected. The mini-base 100′ can also be easily wheeled out of the tent or shelter, if warranted or necessary, for example in the event the mini-base 100′ is no longer needed in that tent or shelter, if the mini-base 100′ requires maintenance or refurbishment, etc.

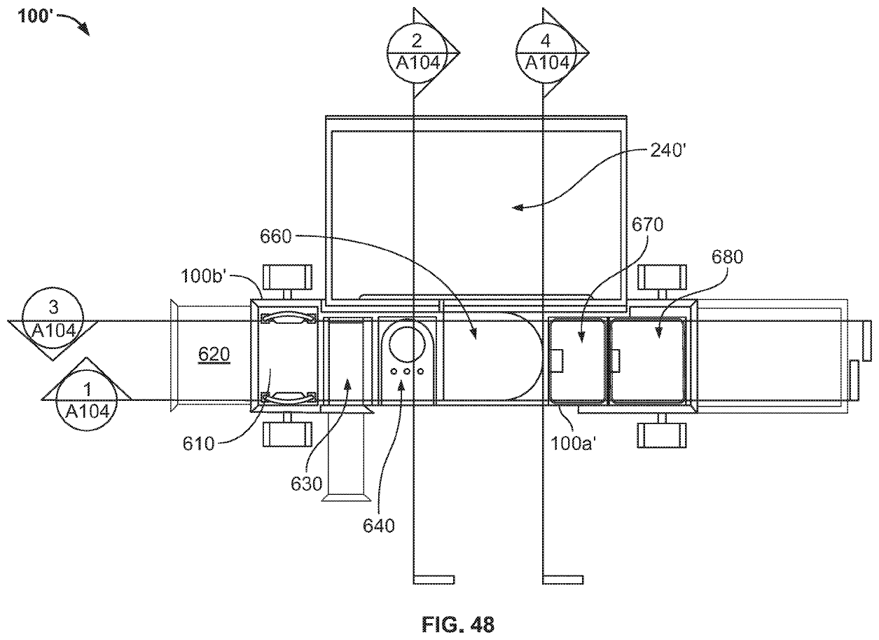

FIG. 48 is a plan section view of a lower elevation of such a mini-base 100′, according to one embodiment of the invention. The dimensioned view depicts the relatively small footprint of the mini-base 100′, occasionally enlarged by the deployment from the rear side 100b′ of a shower tray 240′. At this lowermost level of the mini-base 100′ are compartments for relatively heavy components that are appropriately serviced from this elevation, such as a lithium battery portable power pack 610 on a slide out end tray 620, a storage compartment or open shelving 630 suitable for storing an electric blanket and/or portable ceramic mini heater, for example, and plumbing components such as a water filter 640, water pump 650, WC 660, and one or more water tanks, such as the grey 670 and sweet water tanks 680 depicted here.

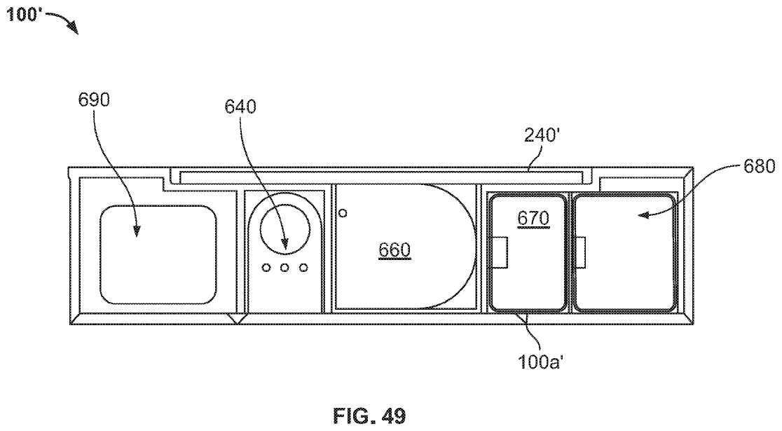

FIG. 49 is a plan section view of a next elevation of the mini-base 100′, above that depicted in FIG. 48. At this level, a small counter top 890 (FIG. 61) is provided for storage of a food preparation appliance 690. The water filter 640 and associated piping, the WC 660, and the water tanks 670, 680 extend up through this elevation.

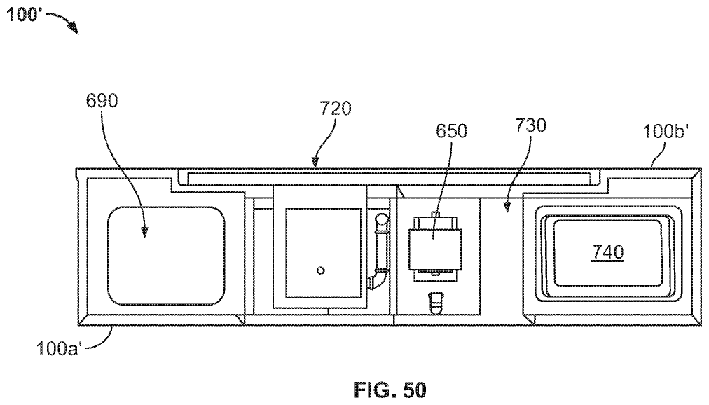

FIG. 50 is a plan section view of the next elevation of the mini-base 100′, above that depicted in FIG. 49. This level can include the food preparation appliance 690, such as a toaster oven, a convection oven, a microwave oven, a hot plate and combinations thereof and the like, to facilitate heating and cooking activities. Generally centrally disposed in the mini-base 100′ at this elevation is a sink 720 with hot and cold water supply accessible from both sides 100a′, 100b′ of the mini-base 100′, along with the water heater 730 and a small refrigerator 740.

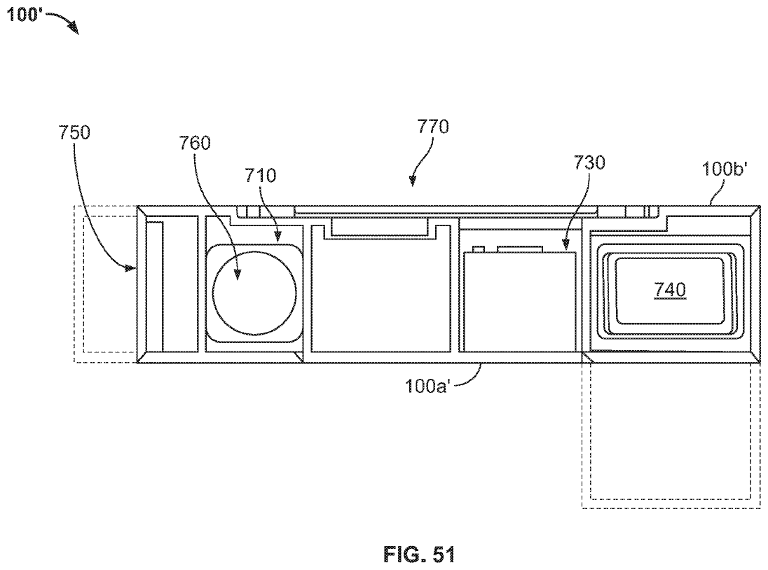

FIG. 51 is a plan section view of the next uppermost elevation of the mini-base 100′, above that depicted in FIG. 50 and below the top cover of the mini-base 100′. This level includes access on one end to the electrical compartment 750 and a cooling fan 760 to induce air circulation in the vicinity of the mini-base 100′. In some variations, the cooling fan 760 may be disposed in a cooling fan compartment 710. A centrally disposed lamp compartment 770 provides a rotatable light 775 for cooking, showering and general use. The water heater 730 and refrigerator 740 extend up into this level.

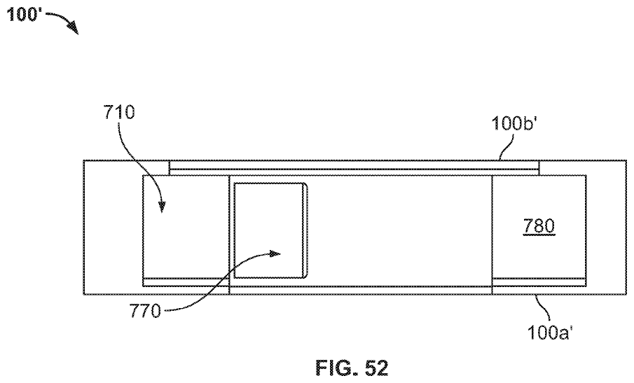

Lastly, the top 780 of the mini-base 100′ is depicted in the uppermost elevation of FIG. 52. The top 780 provides access to the cooling fan 710 and lamp compartments 770.

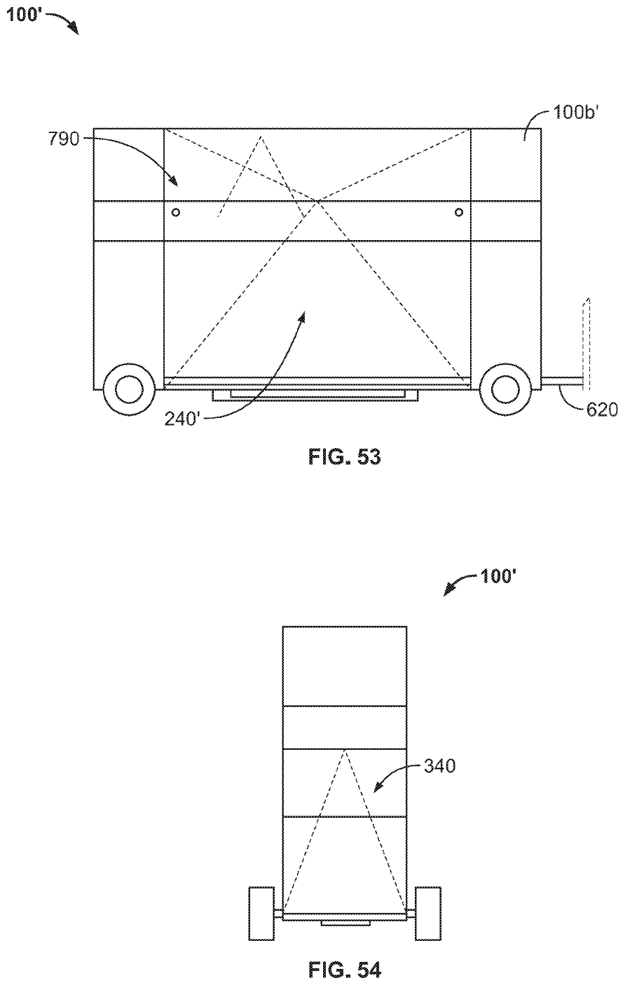

FIGS. 53-54 include schematic rear and right side views of one embodiment of the mini-base 100′, depicting the arrangement and cooperation of the various access doors and compartments. The rear view presents an exemplary arrangement of compartments sized, configured, and located to accommodate personal hygiene and sanitary uses. For example, the rear side 100b′ includes the shower tray 240′, hinged at the bottom to the lowermost portion of the mini-base 100′. The shower top panel 790 is hinged at the top and is able to be vertically extended, to provide support for the shower curtain 250 at a height to ensure privacy for all individuals using the shower, including females. Behind the fold down shower tray 240′ is the WC 660, that will be described in more detail below. The portable lithium power pack sliding tray 620 is depicted in phantom as partially extending from the side of the mini-base 100′.

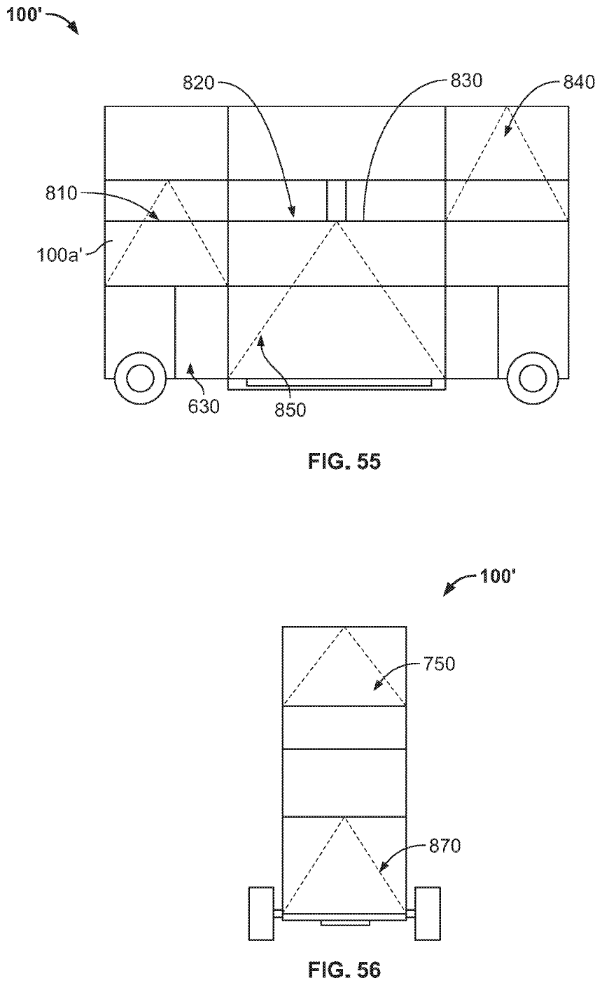

FIGS. 55-56 include schematic front and left side views of one embodiment of the mini-base 100′, depicting the arrangement and cooperation of the various access doors and compartments. The front view presents an exemplary arrangement of compartments sized, configured, and located to accommodate food preparation and comfort. This front side 100a provides access doors or pull out trays or slides for the stove or oven 810, the sink 820, a food preparation worktable 830, and the refrigerator 840. Similarly, access is provided to the heater, electric blanket, and the like 630, as well as to the water filter and pump 850 associated with the plumbing system of the mini-base 100′. End side access is afforded to the electrical control panel 750 and the lithium battery power pack 870.

FIG. 57 is a front section view taken along line 1-A104 of FIG. 48. As can be readily appreciated, the various appliances, fixtures, and MEP components are tightly nested to pack in tremendous functionality in a small volume, while providing easy access for use and routine maintenance and replenishment activities. The mini-base 100′ includes the electrical components (e.g., electrical control compartment 750, cooling fan 760, portable heater 880, storage for an electric blanket or other electrical accessory and the like 630) powered by the lithium battery power pack 610, as well as food preparation and storage devices (e.g., counter top cooking/heating appliance 690, refrigerator 740, etc.) and plumbing components (e.g., wheeled water supply and holding tanks 670, 680, sink 720, water heater 730, water filter 640, water pump 650 (FIG. 590), and WC 660).

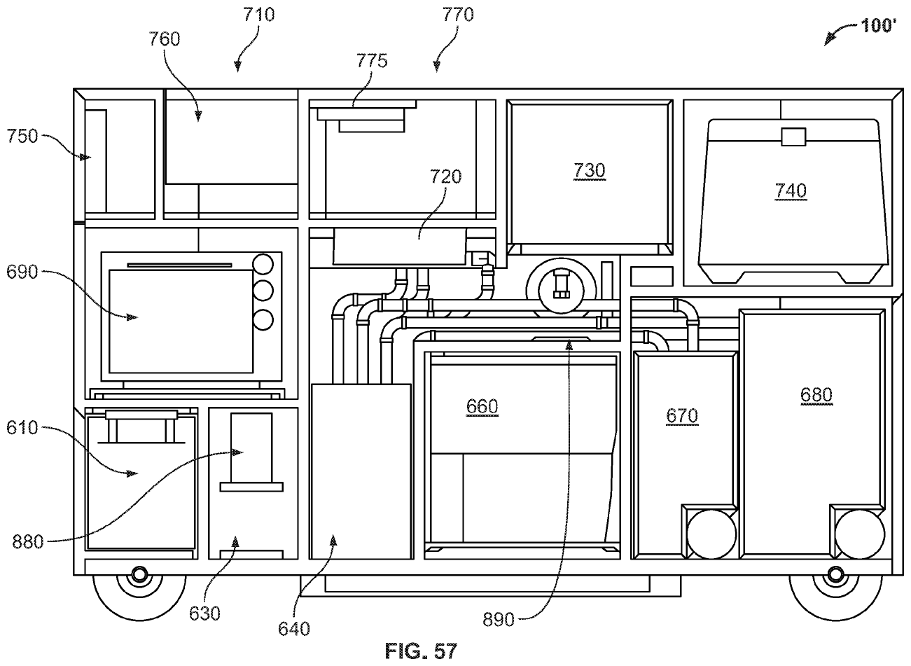

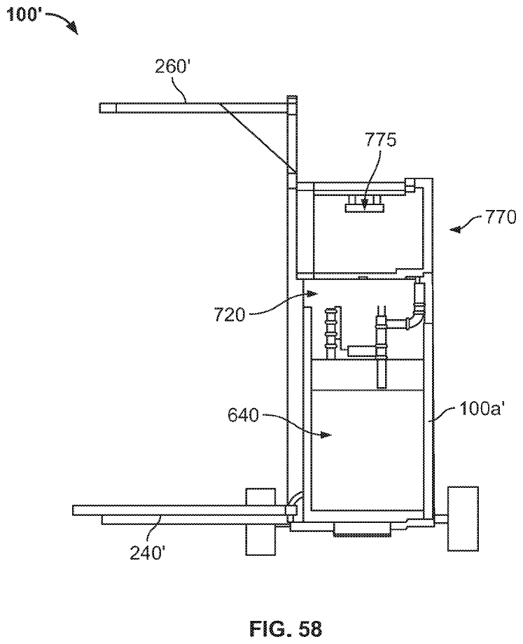

FIG. 58 is an off-center side section view taken along line 2-A104 of FIG. 48 showing the full height of the deployed shower components of about 1.44 m or a little less than five feet. This arrangement provides support for the shower curtain 250 at a height to ensure privacy for all individuals using the shower, including females.

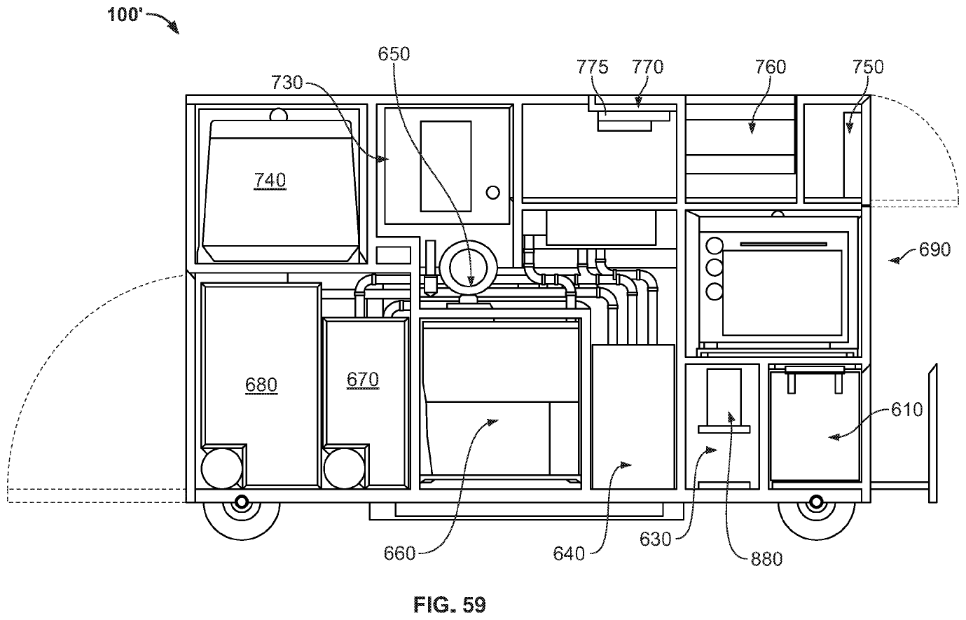

FIG. 59 is a rear section view taken along line 3-A104 of FIG. 48. Similar to the depiction in FIG. 57, the various appliances, fixtures, and MEP components of this embodiment of the mini-base 100′ are tightly nested to pack in tremendous functionality in a small volume, while providing easy access for use and routine maintenance and replenishment activities.

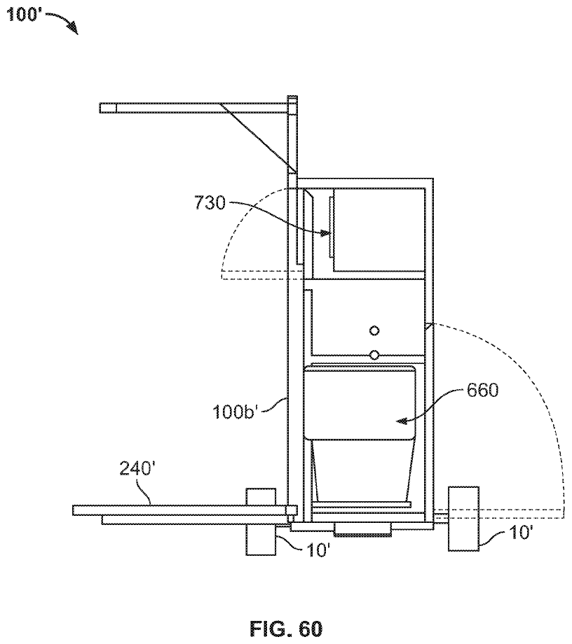

FIG. 60 is another off-center side section view taken along line 4-A104 of FIG. 48 showing the full height of the deployed shower components, with the shower tray 240′ at an elevation of about 0.16 m or a little less than six inches above the ground level, due to the height of the wheels 10′ supporting the mini-base 100′. As will be described in greater detail below, integral adjustable supports are provided with the shower pan 240′ to support the weight of the individual taking a shower, while maintaining the shower tray 240′ with a slight pitch toward the mini-base 100′. This facilitates collection and reuse of the shower water in the grey water system 670 (e.g., for use in the WC 660).

FIG. 61 is an annotated top perspective view of the front 100a′ of the mini-base 100′ with certain components deployed. In particular, this embodiment of the mini-base 100′ includes a general purpose lighting fixture or rotatable lamp 775 that extends from the top of the mini-base 100′ to illuminate the general environs, as well as provide task lighting, in this instance for food preparation. The cooking appliance 690, such as the depicted stove, pulls out of the mini-base 100′ on a sliding support or counter 890. Immediately next to the stove 690 is the sink 720, that conveniently slides out of this front side 100a′ of the mini-base 100′, as well as out of the rear side 100b′ of the mini-base 100′ to service the shower area. See FIG. 63.

More particularly, FIGS. 62-63 are annotated top perspective views of the rear the mini-base 100′ with certain components alternatively deployed. In FIG. 62, the boundaries of the shower are delineated by the fold down shower tray 240′ and the upper extended shower curtain rail 260′. The shower curtain is not present in this depiction, to facilitate depiction of other mini-base 100′ components. For example, the WC 660 is shown in the stowed position, below the water heater compartment accessed by the flip down door 920. FIG. 63 shows the water heater door 920 closed, with the WC 660 slid out for use. The sink 720 is similarly slid out, for access and use on this rear side 100b′ of the mini-base 100′, as part of the sanitary and hygiene functions provided by the mini-base 100′. Immediately above the sink 720 is a recessed shelf 930 to hold soap, shampoo, and other toiletries, and personal care products for use with the sink 720, shower, and WC 660. A polished metal mirror can also be provided.

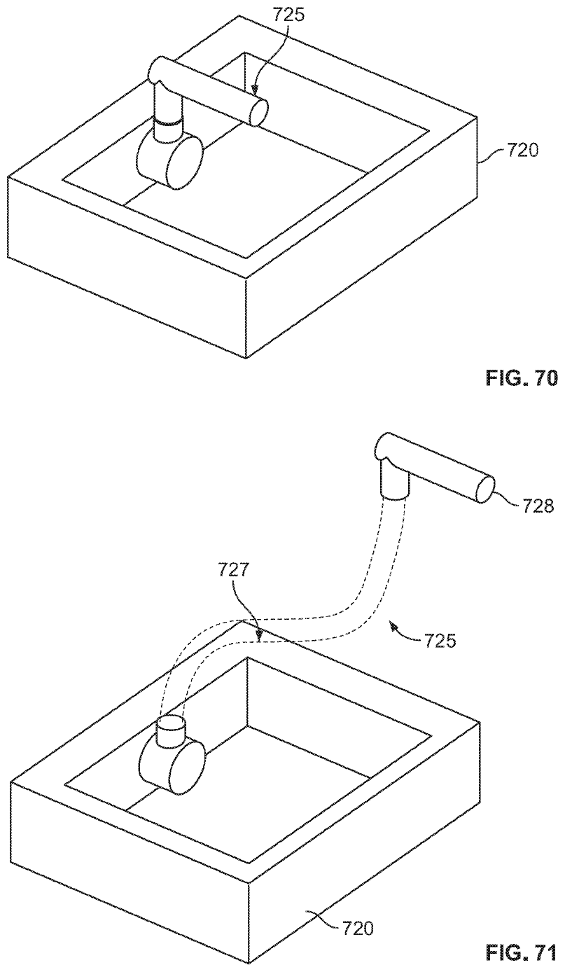

Advantageously, the sink faucet 725 includes a pull out spout 728, as depicted in FIGS. 70-71, that is used for showering and can optionally be temporarily mounted to the shower curtain rail 260′. These annotated enlarged perspective views of the sink 720 outfitted with a pull out faucet 725 in a stowed position and a deployed position, respectively, afford the desired flexibility for food preparation, hand and dish washing, cooking, pot and teapot filling, as well as showering and other personal hygiene activities. The flexible pipe 727 connecting the deployable spout 726 to the sweet water pressurized supply 680 can be any length suitable to extend the spout 728 within the desired cooking and showering work volumes.

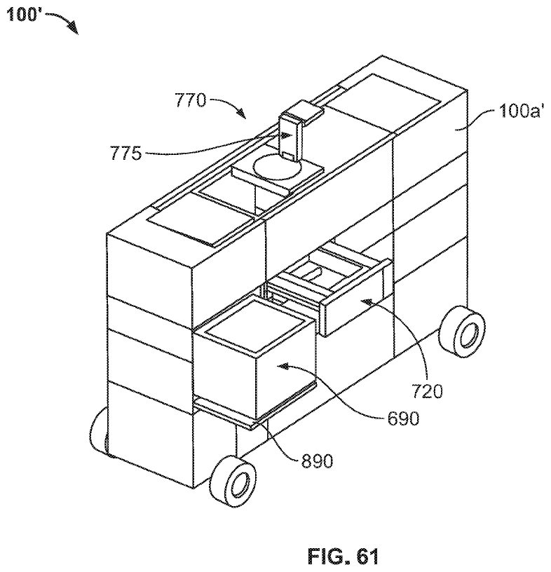

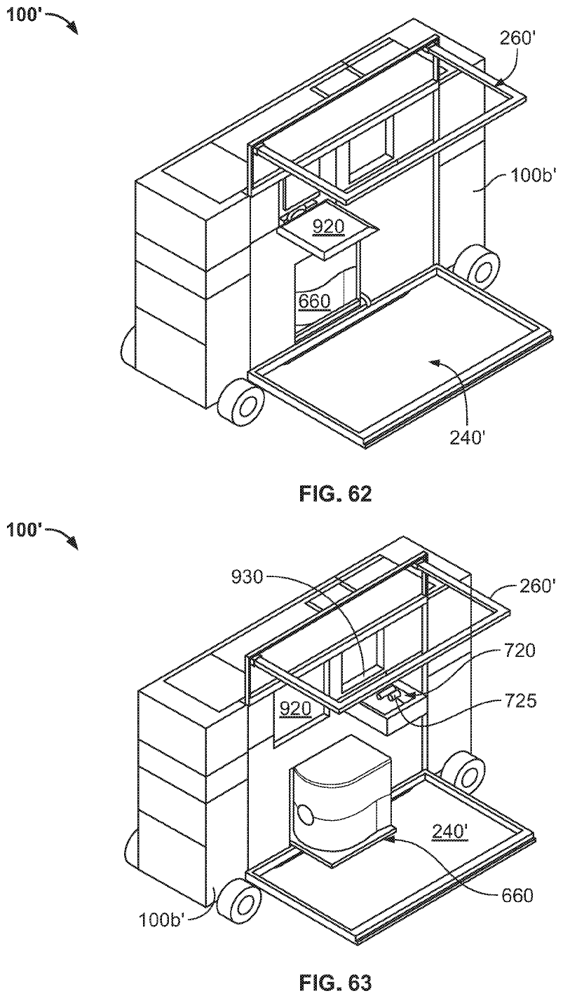

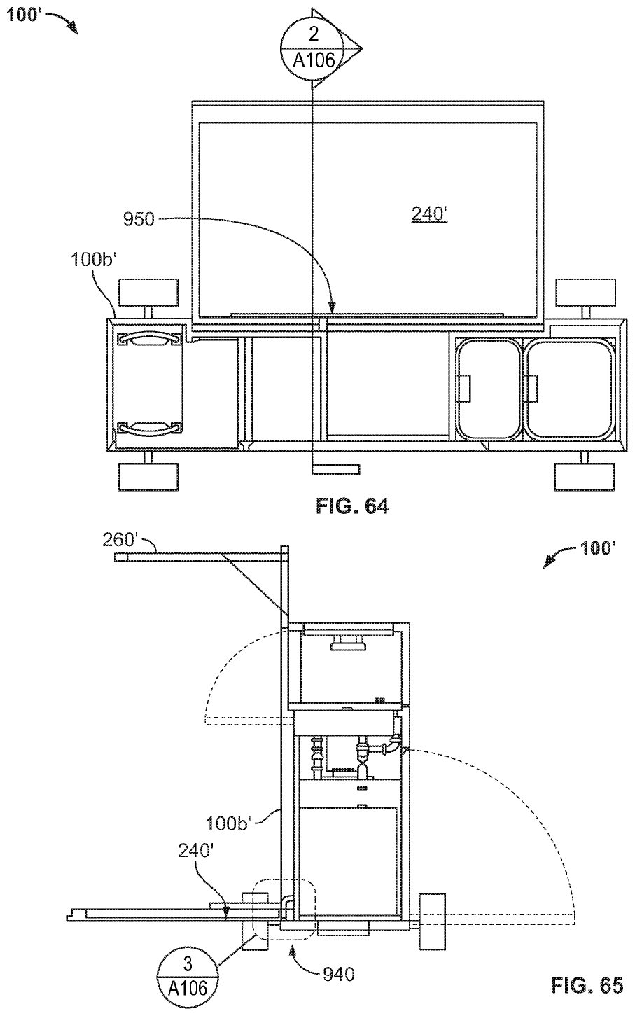

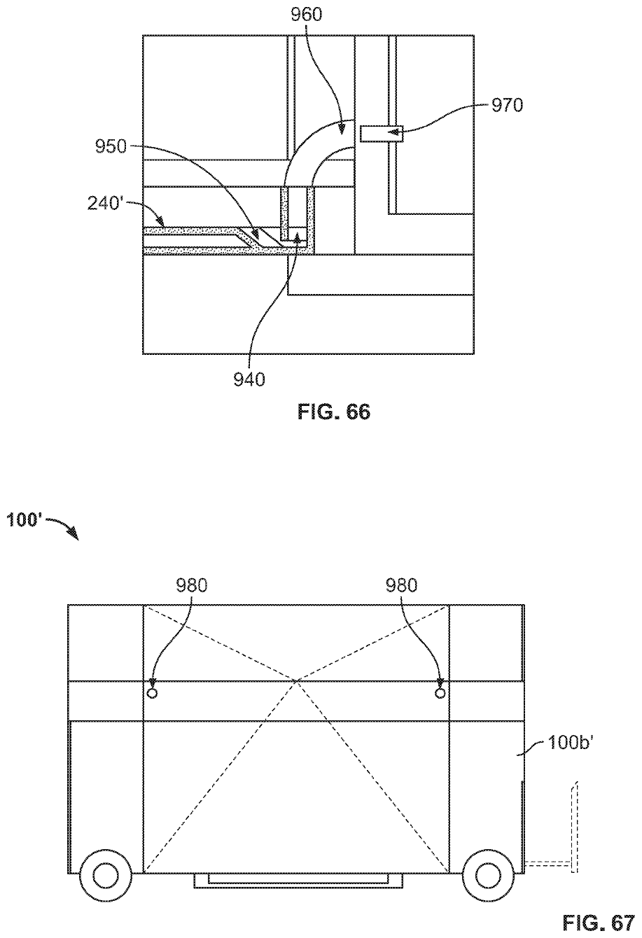

FIGS. 64-66 are, respectively, a top plan view of the mini-base 100′ with the shower tray 240′ deployed, an off-center side section view taken along line 2-A106 of FIG. 64, and an enlarged view of the shower drain 940 at detail 3-A106 of FIG. 65. The rear of the shower tray 240′, where the tray 240′ attaches to the mini-base 100′, includes a depressed trough or gutter 950 to collect the shower water. As best seen in the enlarged detail in FIG. 66, the shower tray 240′ is adjusted on its supports to have a slight pitch (e.g., 2% slope) toward the trough 950. The collected shower water is suctioned by the mini base pump 890, through a flexible pipe connection 960 that automatically extends when the shower tray 240′ is deployed. The water is pumped from the trough 950, through the flexible pipe 960 and associated connector 970 to the grey water storage tank 670 for use in flushing the WC 660.

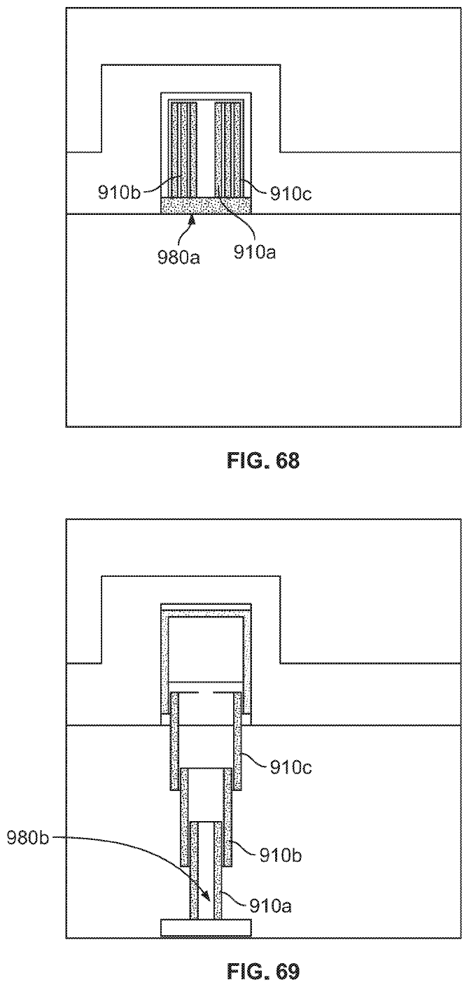

To achieve the desired slight slope of the shower tray 240′ and ensure reliable collection of the shower water for grey water usage, the shower tray 240′ has integral supports or legs 980. FIG. 67 depicts a rear side view of the mini-base 100′ showing the shower tray leg 980 locations and FIGS. 68-69 are annotated enlarged side section views of an adjustable shower leg in a stowed position 980a and a deployed position 980b, respectively. In the depicted embodiment, each leg 980 is of the telescoping type, with nested threaded cylindrical members 910a, 910b, 910c that are able to provide infinitely variable height adjustment within its range, between the stowed 980a and fully deployed 980b longitudinal leg positions. This configuration leg 980 affords the desired precise adjustability in a compact and highly structurally stable design.

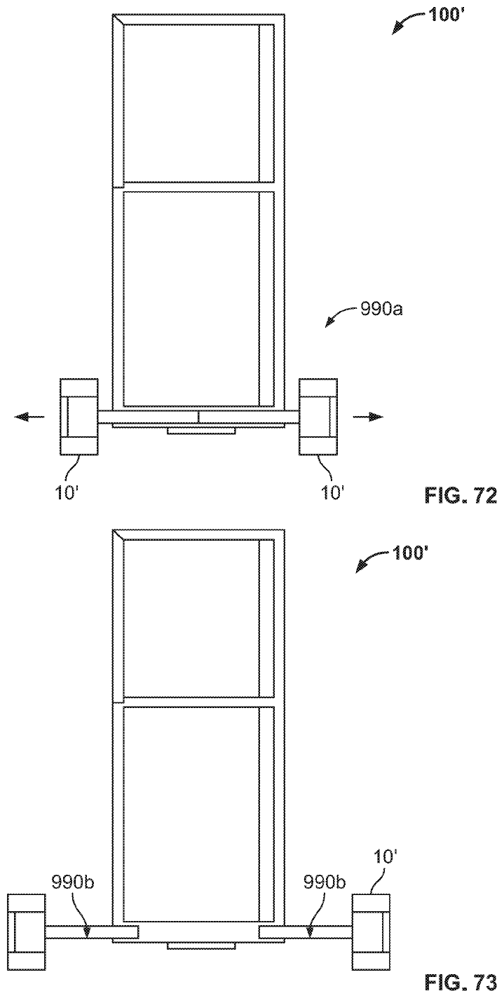

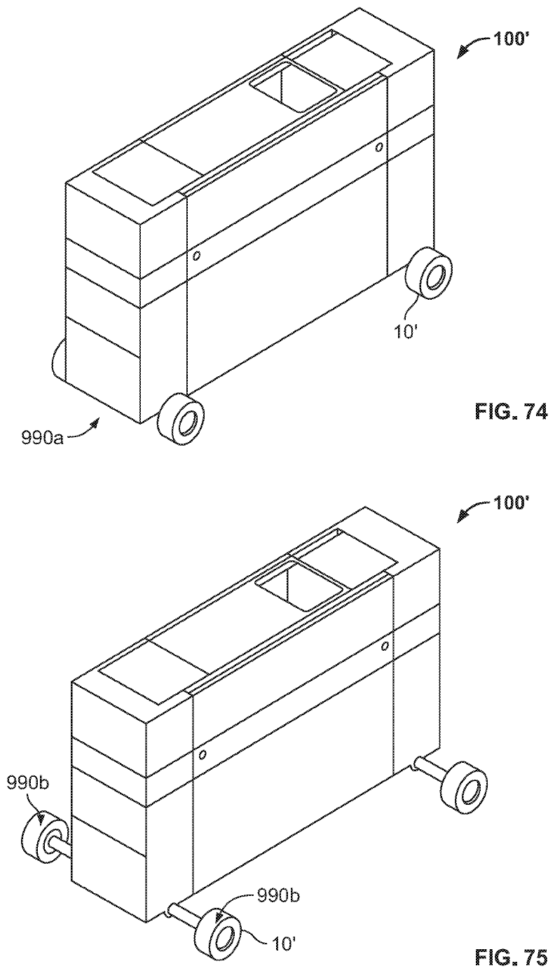

To provide overall stability to the mini-base 100′ and prevent tipping, the two, three, four, or more wheels that support the mini-base 100′ can have extendible wheel axles 990. For example, FIGS. 72-73 are annotated end views of a mini-base 100′ having extendible wheel axles 990 with the wheels 10′ in a retracted or closed position 990a and also in an extended or open position 990b, respectively. FIGS. 74-75 are annotated rear perspective views of the mini-base 100′ having extendible wheel axles 990 with the wheels 10′ in the retracted or closed position 990a and also in the extended or open position 990b, respectively. To prevent inadvertent deployment during storage and transport of the mini-base 100′, a tethered spring wire cotter pin or other manually graspable or releasable component can be provided on each axle that is removed prior to wheel deployment and reinstalled to retain the wheels in their extended positions. Alternatively, in both the mini-base 100′ and the full-sized base 100, the base can have concealed wheels (e.g., internal to the perimeter of the footprint of the frame of the base) that can be extended vertically to engage the ground to permit rolling/positioning of the base and, once the base is located or positioned as desired, the concealed wheels can be retracted so that the base rests on the ground directly or with leveling pads. Any suitable mechanism (e.g., mechanical cam, hydraulic pump ram, etc.) can be used to individually, in pairs, or collectively deploy and retract the wheels. In one embodiment, the wheel deployment and retraction mechanism is only actuated when movement of the base is required.

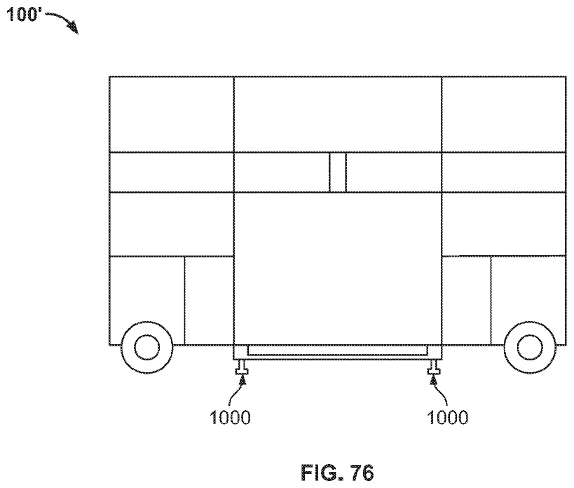

Moreover, to facilitate deployment, the vertical loads on the wheels can be temporarily alleviated by mechanical lifts 1000. FIG. 76 is a schematic front view of the mini-base 100′ having lifting jacks 1000 to elevate the mini-base 100′. Similar to the shower legs 990, these lifts 1000 can be threaded inserts that can be unscrewed to contact the ground and jack or lift a corner or end of the mini-base 100′ when deploying the wheels 10′. A spanner or wrench can be provided in a holder or tethered to the mini-base 100′ to ensure the availability of the tool to turn the jacks. Alternatively, the threaded shaft of each jack can include a hole through which a captured sliding rod passes, akin to the handle arrangement used with a bench vise, to provide the desired mechanical leverage to turn easily the jacking screws.

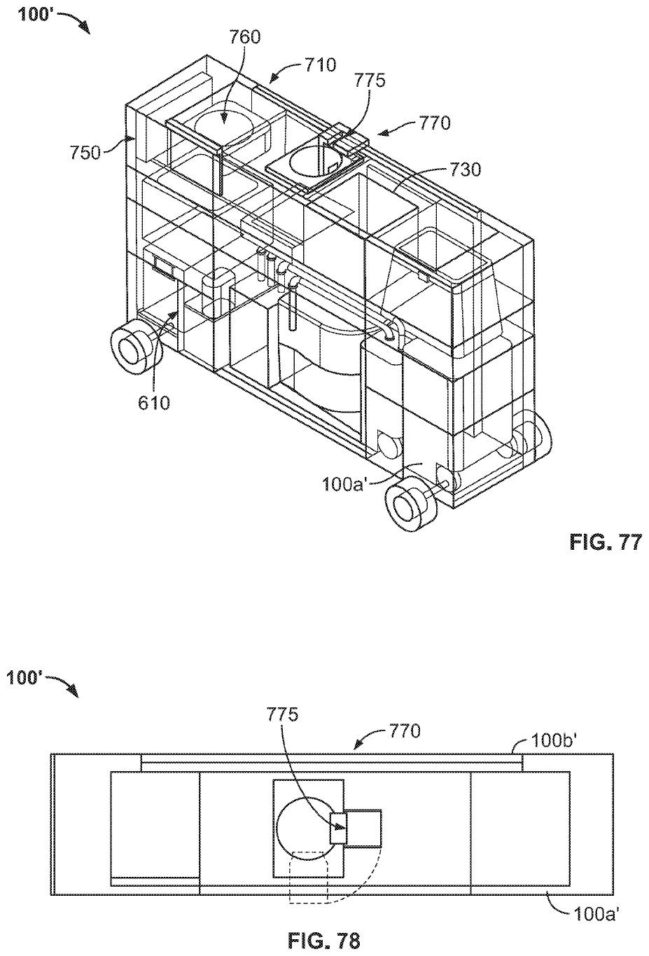

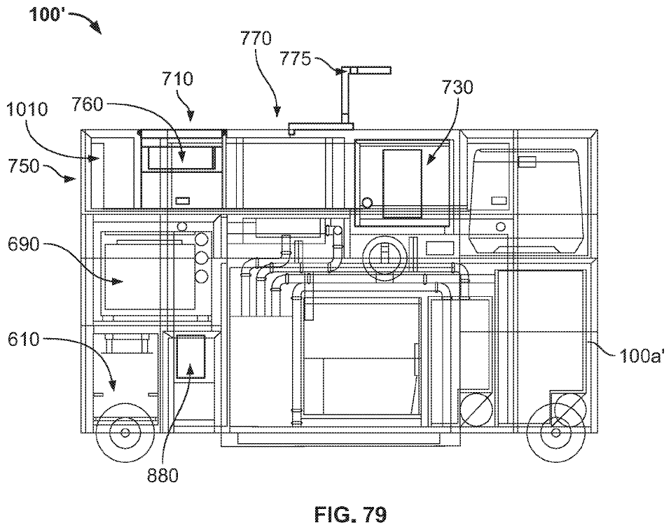

FIGS. 77-79 are annotated top perspective, enlarged top, and front phantom views of the mini-base 100′ from the front, focusing on certain of the electrical system components of the mini-base 100′. In particular, in this embodiment, the heavy portable lithium battery pack 610 is provided in a lower portion of the mini-base 100′, to facilitate removal, recharging, replacement, etc., along with the portable heat devices 880. The electrical control panel 750 and compartments for the extendible cooling fan 710 and 360 degree rotatable lamp 770 are located at an upper portion of the mini-base 100′, as is the water heater 730.

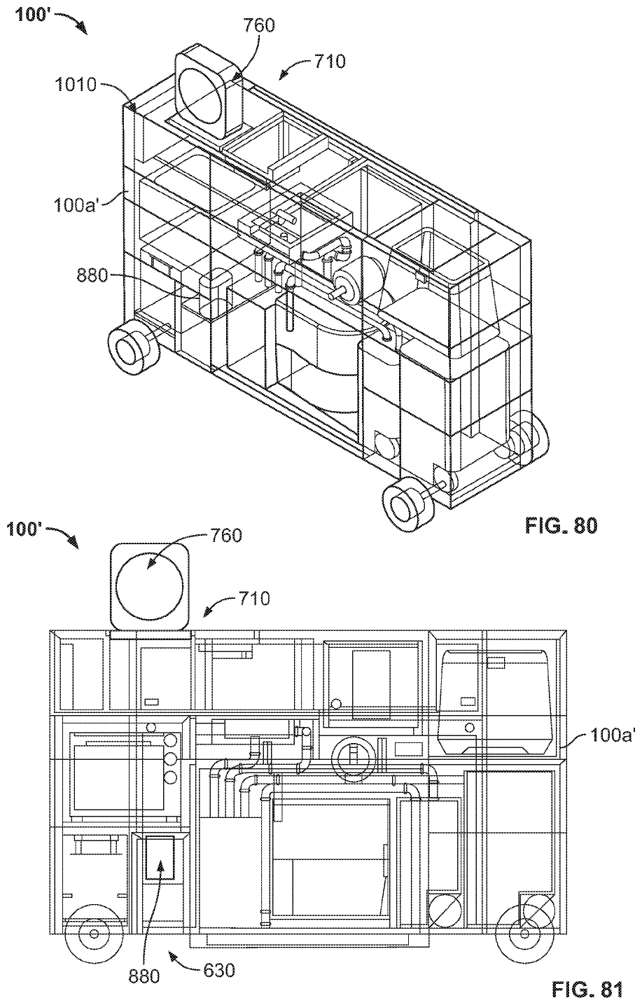

FIGS. 80-81 are annotated top perspective and front phantom views of the mini-base 100′ from the front, focusing on certain of the HVAC components of the mini-base 100′, namely the cooling fan 760 locatable within a cooling fan compartment 710 atop the mini-base 100′ and the portable mini heater 880 stowed in the lower compartment 630.

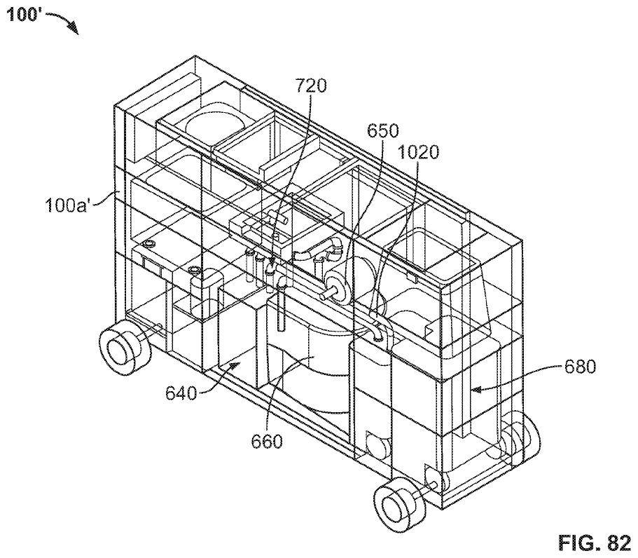

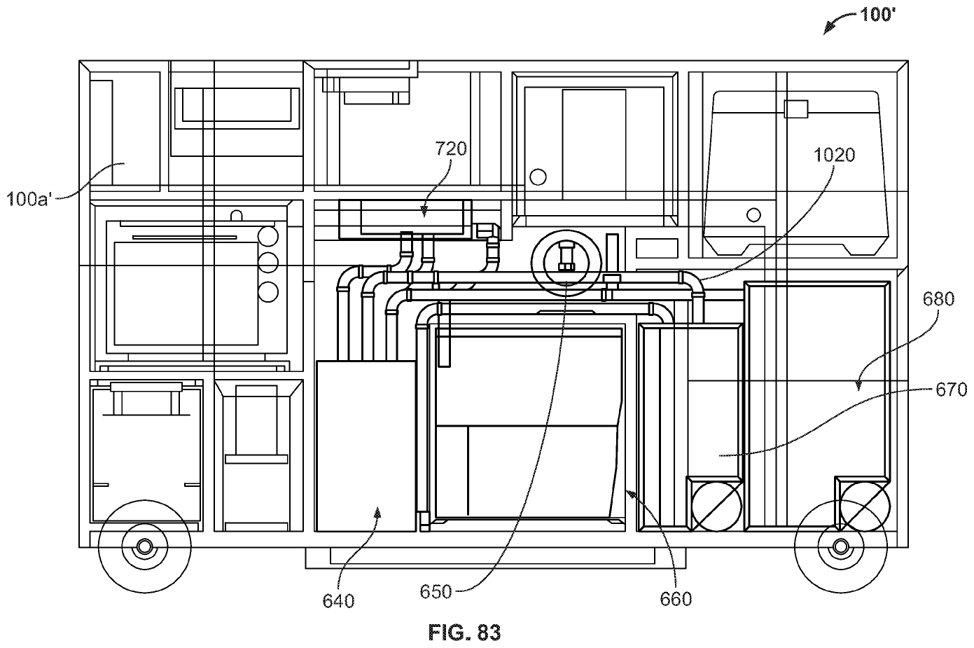

Certain of the plumbing system components of the mini-base 100′ are best seen in the annotated top perspective and front phantom views of the mini-base 100′ from the front 100a′ shown in FIGS. 82-83. On either side of the WC 660, that is centrally located in the lower portion of the mini-base 100′, are the water filter system 640 and sink 720 to one side and the sweet 680 and grey water tanks 670 on the other side. The associated supply and drain piping 1020 interconnecting all of the water-based appliances and fixtures are routed in transverse and generally inverted U-shaped paths. The sweet 680 and grey water tanks 670 are located in the compartment accessible from the side of the mini-base 100′ and can include integrally molded handles, as well as wheels, to facilitate tank removal, cleaning, refilling, etc.

In various embodiments, the orientation of the base 100, 100′ need not be vertical, but can have a more horizontal orientation with components, fixtures, and appliances being accessible or extended in the horizontal and/or vertical direction. While the described and depicted embodiments have a generally rectilinear external shape, the base 100, 100′ can be any size or orientation suitable to the temporary housing application and desired functionality. Moreover, the base 100, 100′ need not have rectilinear edges and flat exterior surfaces forming a box-shaped or prismatic structure; but, rather, could alternatively or additionally include contoured exterior surfaces or portions thereof (e.g., contours that are convex, concave, undulating, etc.) to achieve a desired aesthetic appearance and/or provide a utilitarian function, such as forming a semi-arcuate enclosure for the shower.

The exposed upper and other exterior portions of the base 100, 100′ may be covered or enclosed with any suitable weather resistant roofing or other material. Similarly, the exposed vertical faces of the front, rear, and sides of the base 100, 100′ may include housing surfaces or external cladding of any suitable material (e.g., wood, metal, ceramic, polymer, composite, etc.), both for environmental protection and the desired aesthetic appearance.

The base 100, 100′ may be formed with a housing (e.g., molded fiber-reinforced resin, such as fiberglass) or may be formed of a clad structural frame for supporting portions of the MEP systems, appliances, and fixtures disposed in the plurality of internal compartments formed therein. The base 100, 100′ can include lifting points structurally integral with or connected to the frame to facilitate transport, installation, and/or removal of the base 100, 100′ with a crane and/or forklift cavities. Alternatively or additionally, the base 100, 100′ can be wheeled into position. Alternatively, connecting points (e.g., for connecting the base to another base(s), grid(s), a supply or discharge system/network, and the like) may be included.

Once in place, the frame may be left free-standing or anchored to the ground, to prevent movement and tipping. The housing or frame may be of any suitable construction, such as structural steel or aluminum members, fiberglass reinforced polymers, etc. Depending on the construction technique, the base 100, 100′ may utilize modular construction components, facilitating changes or modifications to the base 100, 100′. For example, the base 100, 100′ can be enlarged, modified, or reduced in size after manufacture and prior to deployment, depending on the needs of the displaced individuals and the local environmental conditions. In certain situations, the base 100, 100′ can be modified, in situ. Alternatively or additionally, the internal layout of the base 100, 100′ can be modified in advance or in situ to add, remove, resize, and/or reconfigure one or more compartments to accommodate changes in the MEP systems, fixtures, or appliances required for the temporary enclosure and its occupants. These changes could be the result of additions or modifications to the encampment, the potential to tie into centralized MEP systems servicing the encampment, and/or due to advances in appliance and fixture technology. Accordingly, the base 100, 100′ and its associated functionality can be transformed and evolve as the needs of the inhabitants grow and technology evolves.

In general, the base 100, 100′ is a free-standing, structurally independent element, without the need for temporary or permanent connections to other utility sources, supplies, or drains. To the extent such utilities exist and are accessible at the tent or shelter, connections between distribution and collections systems located proximate to the tent or shelter may be accommodated, but are not required. The frame is configured and reinforced to accommodate the static and dynamic loads expected to be encountered during transport, as well as during routine and peak usage, with sufficient margin to ensure safe operation and reliable performance.

The exterior of the housing and/or the external cladding of the base 100, 100′ can be configured as openable panels, for example hinged panels or doors to access the internal compartments, or, alternatively, as a plug-in compartment that contains original, built-in fixtures or appliances. In other embodiments, portions of the housing or cladding can be removable, for example being attached with machine screws, clips, etc., and/or portions may be permanently attached with rivets, adhesives, etc. to those areas not requiring access. In general, access is provided for installation, maintenance, and replacement of MEP system components located in the compartments, as well as general servicing of the base 100, 100′. The housing and/or cladding can be made of a material and have a finished surface both suitable for exposure to an interior living space of the tent or shelter, as well as a weather-resistant surface suitable for exposure to ambient environment external to the tent or shelter.

The base 100, 100′ may also optionally be provided with a controller or control panel having a user interface, such as a touch screen display, for diagnostics. The user interface may provide status information on the base 100, 100′, as well as status information on the MEP system components, fixtures, and appliances housed therein. The user interface may be a physical keyboard, touch screen display, local software application, downloadable software application accessible via smartphone or other smart device, etc.

Each compartment of the base 100, 100′ can include the necessary service ports to support components of the integrated network including, for example, electrical power cabling, data/communications cabling, temperature control ducting, fluid supply piping, fluid return piping, etc. for servicing the fixtures and appliances located therein.

As noted above, the base described here in may be used in a temporary habitable enclosure to provide utilities to occupants thereof, the base including a housing forming a plurality of compartments, each compartment containing at least a portion of an MEP system, an appliance, or a fixture. Housing may enclose and provides access to the compartments, and an integrated network may interconnect the MEP systems with the fixtures, and the appliances. The appliances or fixtures may be point-of-use or original customized appliances and fixtures. The base may be placed in an interior of the temporary habitable enclosure and at least one MEP system, fixture or appliance of the base may be deployed and used. Such use may include a base that can be used with or without a fixture or appliance. For example, the MEP system can be connected to one or more of: a solar panel system (e.g., to charge the battery), a battery charger, a generator, and/or a power supply grid, and the like. A water tank can be filled manually or connected to a water supply tank or water supply grid. Used water can be discharged manually or connected to a drainage tank or a drainage grid. Grey water can be reused within the base for single-cycle (i.e., flushing a WC) or can be collected in the base water collection tank for manual discharge. Alternatively, it can be connected to a grey water discharge exterior tank or grid system. Blackwater can be reused within the base for single-cycle (e.g., biogas, generating electricity, etc.). Alternatively, blackwater may be discharged manually as bio-elements (e.g., for farming), and/or can be collected in the base blackwater collection tank for manual discharge. Alternatively, the base can be connected to a blackwater discharge exterior tank and/or a grid system.

Any parameters, materials, dimensions, values, and the like described herein are by way of example only and shall not be considered limiting in any regard. These parameters and values are meant to convey the wide range of specifications various bases can achieve in meeting individuals' needs across a wide variety of applications. Further, while the focus of various embodiments described herein in detail has been primarily related to temporary housing encampments, other embodiments of the invention have wider applicability, including use in semi-permanent and more permanent enclosures.

Having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A base adapted for use in a temporary habitable enclosure to provide utilities to occupants thereof, the base comprising:
a housing forming a plurality of compartments, each compartment containing at least a portion of a mechanical, electrical, and plumbing (MEP) system, an appliance, or a fixture, wherein the housing encloses and provides access to the compartments; and
an integrated network interconnecting some portion of the MEP system with at least one of the fixture or the appliance.

2. The base of claim 1, wherein:
the MEP systems comprise at least one ambient environment regulating device;
the fixtures comprise at least one plumbing device and one lighting device; and
the appliances comprise at least one cooking device.

3. The base of claim 1, wherein the housing comprises a structural frame comprising a substantially rectilinear external shape.

4. The base of claim 1, wherein the housing comprises external cladding comprising at least one removable panel.

5. The base of claim 4, wherein the external cladding comprises at least one openable panel.

6. The base of claim 4, wherein the external cladding comprises at least one of a finished surface suitable for exposure to an interior living space of the temporary habitable enclosure, or a weather-resistant surface suitable for exposure to ambient environment external to the habitable enclosure, or combinations thereof.

7. The base of claim 1, wherein components of the integrated network are selected from the group consisting of electrical power cabling, data/communications cabling, environment regulating ducting, fluid supply piping, fluid drain piping, and combinations thereof.

8. The base of claim 1 further comprising a controller for monitoring a status of the MEP system.

9. The base of claim 8, further comprising a user interface providing user access to the controller.

10. The base of claim 1, further comprising at least one of: connecting points, lifting points, forklift cavities, or wheels to facilitate transport, installation, or removal of the base in the temporary habitable enclosure.

11. The base of claim 1, wherein the MEP system is selected from the group consisting of an electrical energy collection system, an electrical energy distribution system, an electrical energy storage system, an electrical energy conditioning/inverter system, a potable water system, a grey water system, a black water system, an HVAC system, a data/communications system, a distribution board/interface, a fire detection and alarm system, a fire-fighting system, a security system, a voice and data system, transformersubstations, and emergency power generator connections.

12. The base of claim 2, wherein the at least one plumbing device is selected from the group consisting of a bidet, a shower, a sink, a toilet, and a urinal.

13. The base of claim 2, wherein the at least one cooking device is selected from the group consisting of an oven, a microwave oven, a grill, a refrigerator, an all-in-one cooker, and a stove.

14. The base of claim 2, wherein the at least one lighting device is selected from the group consisting of a rotatable lamp, a nightlight, and a spotlight.

15. The base of claim 2, wherein the at least one ambient environment regulating device is selected from the group consisting of an air conditioner, a boiler, a dehumidifier, a furnace, a heater, a fan, an HVAC system, an air purifier, a heated blanket, power supply sockets/connectors, and components thereof.

16. A method of manufacturing a base adapted for use in a temporary habitable enclosure to provide utilities to occupants thereof, the method comprising the steps of:
manufacturing a housing forming a plurality of compartments, wherein the housing encloses and/or provides access to the compartments;
installing in each compartment at least one of a portion of an MEP system, an appliance, or a fixture; and
installing an integrated network in the housing interconnecting the MEP system, the fixture, and appliance.

17. A method of using a base in a temporary habitable enclosure to provide utilities to occupants thereof, the base comprising a housing forming a plurality of compartments, each compartment containing at least a portion of an MEP system, an appliance, or a fixture, wherein the housing encloses and/or provides access to the compartments, and an integrated network interconnecting the MEP system, the fixture, and the appliance, the method comprising the steps of:
disposing the base in an interior of the temporary habitable enclosure; and
using at least one MEP system, fixture, or appliance.
